(19) United States
(12) Patent Application Publication
(10) Pub. No.: US 2007/0144820 A1
(43) Pub. Date: Jun. 28, 2007

(54) Power steering apparatus

(75) Inventors: Masakazu Kurata, Yokohama (JP); Toshimitsu Sakaki, Kanagawa (JP)

Correspondence Address: FOLEY AND LARDNER LLP;SUITE 500, 3000 K STREET NW, WASHINGTON, DC, 20007, US

(73) Assignee: HITACHI, LTD.

(21) Appl. No.: 11/643,806

(22) Filed: Dec. 22, 2006

(30) Foreign Application Priority Data
Dec. 26, 2005 (JP) 2005-371510

(51) Int. Cl. B62D 5/00

(52) U.S. Cl. 180/442

(57) ABSTRACT

A power steering apparatus includes a power cylinder including first and second pressure chambers, a hydraulic pump including first and second discharge ports, the hydraulic pump being arranged to supply a hydraulic pressure selectively to the first and second pressure chambers; first and second hydraulic passages connecting the first and second pressure chambers and the first and second discharge ports; a motor arranged to drive the hydraulic pump; a motor control section configured to output a drive signal to the motor; a reservoir tank storing a hydraulic fluid; first and second bypass passages connecting the first and second hydraulic passages and the reservoir tank; first and second bypass valves arranged to open and close the first and second bypass passages; and first and second flow rate restricting sections disposed in the first and second bypass passages, and arranged to decrease flow rates of the first and second bypass passages.

### BACKGROUND OF THE INVENTION

The present invention relates to a hydraulic power steering apparatus.

U.S. Patent Application Publication 2005/0023073 (A1) (corresponding to Japanese Patent Application Publication 2003-047296) shows a power steering apparatus including an electric motor, a power cylinder having left and right cylinders, and a reversible pump driven by the electric motor, and arranged to supply a hydraulic pressure selectively to the left and right cylinders so that the power steering apparatus gains a steering assist force.

For example, in a case in which the right cylinder is supplied with the hydraulic pressure, the pressure within a right side hydraulic passage is increased above all in a state in which a handle is abutted, so that the right side hydraulic passage is expanded. A volume of a piping is increased by the expansion, so that the hydraulic fluid is deficient. The deficiency of the hydraulic fluid is compensated from the reservoir tank through a check valve.

The fluid pressure supplied to the right side hydraulic passage is also supplied to a return check valve, and the return check valve of a left side return hydraulic passage is opened. Consequently, the return check valve of the left side hydraulic passage is opened, and the left side hydraulic passage is connected with the reservoir tank. Then, when the supply of the fluid pressure to the right side cylinder is stopped, the hydraulic fluid within the right side cylinder flows into the left side hydraulic passage.

### SUMMARY OF THE INVENTION

However, in the above mentioned power steering apparatus, the increase of the hydraulic fluid which has flowed into the left side hydraulic passage, and which is caused by the expansion of the right side hydraulic passage is discharged through the return check valve to the reservoir tank with a contraction of the right side hydraulic passage. When the return check valve of the left side hydraulic passage is closed with the decrease of the fluid pressure of the right side hydraulic passage, the flow of the hydraulic fluid flowing from the left side hydraulic passage to the reservoir tank is suddenly shut off. In this power steering apparatus, there is a problem to cause abnormal noise by the noise of the impact of the hydraulic fluid whose the flow is shut off.

It is therefore an object of the present invention to provide a power steering apparatus devised to avoid generation of noise of impact of hydraulic fluid.

According to one aspect of the present invention, a power steering apparatus comprises: a power cylinder including first and second pressure chambers, the power cylinder being arranged to assist a steering force of a steering mechanism connected with steered wheels; a hydraulic pump including a first discharge port and a second discharge port, the hydraulic pump being arranged to supply a hydraulic pressure selectively to the first pressure chamber and the second pressure chamber; a first hydraulic passage connecting the first pressure chamber of the power cylinder and the first discharge port of the hydraulic pump; a second hydraulic passage connecting the second pressure chamber of the power cylinder and the second discharge port of the hydraulic pump; a motor arranged to drive the hydraulic pump; a motor control section configured to output a drive signal to the motor in accordance with a steering assist force applied to the steered wheels; a reservoir tank storing a hydraulic fluid; a first bypass passage connecting the first hydraulic passage and the reservoir tank; a second bypass passage connecting the second hydraulic passage and the reservoir tank; a first bypass valve arranged to open and close the first bypass passage; a second bypass valve arranged to open and close the second bypass passage; a first flow rate restricting section disposed in the first bypass passage, and arranged to decrease a flow rate of the first bypass passage; and a second flow rate restricting section disposed in the second bypass passage, and arranged to decrease a flow rate of the second bypass passage.

According to another aspect of the invention, a power steering apparatus comprises: a power cylinder including first and second pressure chambers, the power cylinder being arranged to assist a steering force of a steering mechanism connected with steered wheels; a hydraulic pump including a first discharge port and a second discharge port, the hydraulic pump being arranged to supply a hydraulic pressure selectively to the first pressure chamber and the second pressure chamber; a first hydraulic passage connecting the first pressure chamber of the power cylinder and the first discharge port of the hydraulic pump; a second hydraulic passage connecting the second pressure chamber of the power cylinder and the second discharge port of the hydraulic pump; a motor arranged to drive the hydraulic pump; a motor control section configured to output a drive signal to the motor in accordance with a steering assist force applied to the steered wheels; a reservoir tank storing a hydraulic fluid; a first bypass passage connecting the first hydraulic passage and the reservoir tank; a second bypass passage connecting the second hydraulic passage and the reservoir tank; a first bypass valve arranged to open and close the first bypass passage; a second bypass valve arranged to open and close the second bypass passage; a first pressure-decrease restricting section provided in the first bypass passage, and arranged to decrease a speed of a pressure decrease on an upstream side of the first bypass valve; and a second pressure-decrease restricting section provided in the second bypass passage, and arranged to decrease a speed of a pressure decrease on an upstream side of the second bypass valve.

According to still another aspect of the invention, a power steering apparatus comprises: a power cylinder including first and second pressure chambers, the power cylinder being arranged to assist a steering force of a steering mechanism connected with steered wheels; a hydraulic pump including a first discharge port and a second discharge port, the hydraulic pump being arranged to supply a hydraulic pressure selectively to the first pressure chamber and the second pressure chamber; a first hydraulic passage connecting the first pressure chamber of the power cylinder and the first discharge port of the hydraulic pump; a second hydraulic passage connecting the second pressure chamber of the power cylinder and the second discharge port of the hydraulic pump; a motor arranged to drive the hydraulic pump; a motor control section configured to output a drive signal to the motor in accordance with a steering assist force applied to the steered wheels; a reservoir tank storing a hydraulic fluid; a first bypass passage connecting the first hydraulic passage and the reservoir tank; a second bypass passage connecting the second hydraulic passage and the reservoir tank; a first bypass valve arranged to open and close the first bypass passage; a second bypass valve arranged to open and close the second bypass passage; a first valve movement restricting section provided in the first bypass valve, and arranged to decrease a speed per unit time of the first bypass valve; and a second valve movement restricting section provided in the second bypass valve, and arranged to decrease a speed per unit time of the second bypass valve.

### BRIEF DESCRIPTION OF THE DRAWINGS

FIG. 1 is a block diagram showing a power steering apparatus according to a first embodiment of the present invention.

FIG. 2 is a top view showing a pump apparatus when a second housing is detached.

FIG. 3 is a top view showing a first housing.

FIG. 4 is an axial sectional view showing the pump apparatus, and taken along a section line II-II of FIGS. 2 and 3.

FIG. 5 is a sectional view taken along a section line I-I of FIGS. 2 and 3.

FIG. 6 is a sectional view taken along a section line III-III of FIG. 5.

FIG. 7 is a front view showing a bypass valve, as viewed from a positive direction of in a z-axis.

FIG. 8 is a sectional view taken along a sectional line IV-IV of FIG. 7.

FIG. 9 is a sectional view taken along a sectional line V-V of FIG. 7.

FIG. 10 is a sectional view taken along a sectional line IV-IV, and showing the bypass valve at a pressure increasing assist of the first cylinder.

FIG. 11 is a sectional view taken along a sectional line IV-IV, and showing the bypass valve at a pressure increasing assist of the second cylinder.

FIG. 12 is a front view showing a bypass valve of earlier technology, as viewed from a positive direction of a z-axis direction.

FIG. 13 is a sectional plan view as if cut by an x-z plane, of the bypass valve of an earlier technology.

FIG. 14 is a sectional plan view as if cut by the x-z plane, of the bypass valve of the earlier technology.

FIG. 15A is a time chart showing an assist control in a low steering angular speed region of the power steering apparatus according to the embodiment of the present invention. FIG. 15B is a time chart showing an assist control in a low steering angular speed region of the power steering apparatus of the earlier technology.

FIG. 16 is a time chart showing an assist control in a high steering angular speed region of the power steering apparatus according to the embodiment of the present invention.

FIG. 17 is a time chart showing an assist control in a high steering angular speed region of the power steering apparatus of the earlier technology.

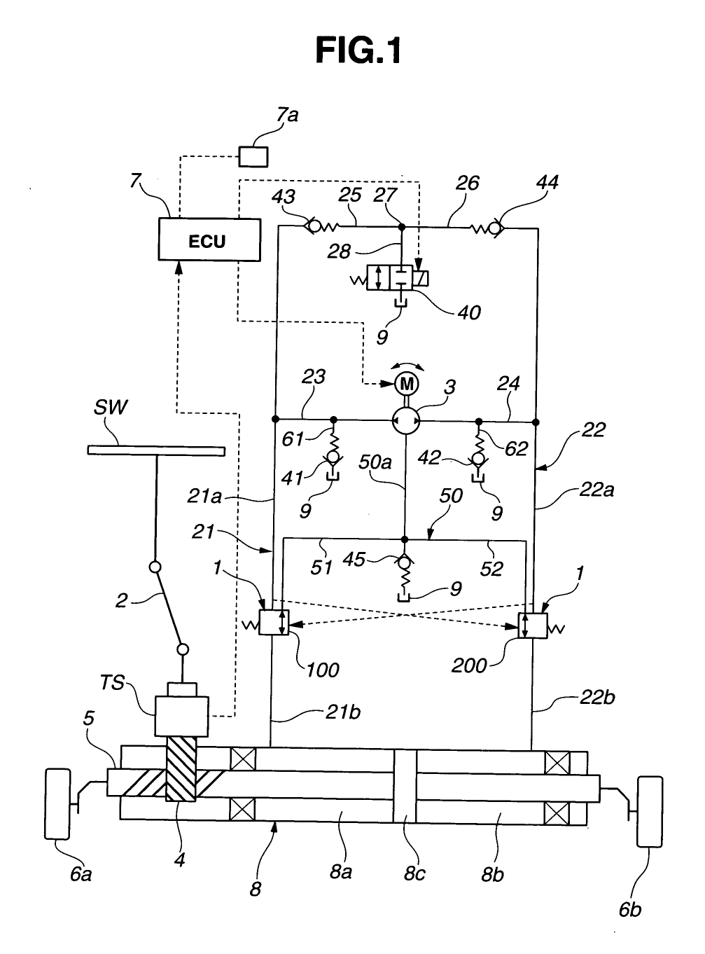

### DETAILED DESCRIPTION OF THE INVENTION

[POWER STEERING SYSTEM CONFIGURATION] FIG. 1 is a view showing a system configuration of a power steering apparatus according to a first embodiment of the present invention. When a driver steers a steering wheel SW, a pinion 4 is driven through a shaft 2. Then, a rack shaft 5 is axially moved by a rack and pinion mechanism (steering mechanism), so as to steer a front wheels. A torque sensor TS is provided at shaft 2, and arranged to sense a driver's steering torque, and to output a torque signal to a control unit 7 (motor control section).

Rack shaft 5 is provided with a power steering mechanism arranged to assist movement of rack shaft 5 in accordance with the driver's steering torque. This power steering mechanism includes a reversible pump 3 driven by a motor M, and a power cylinder 8 arranged to move rack shaft 5 in right and left directions (as shown in FIG. 1).

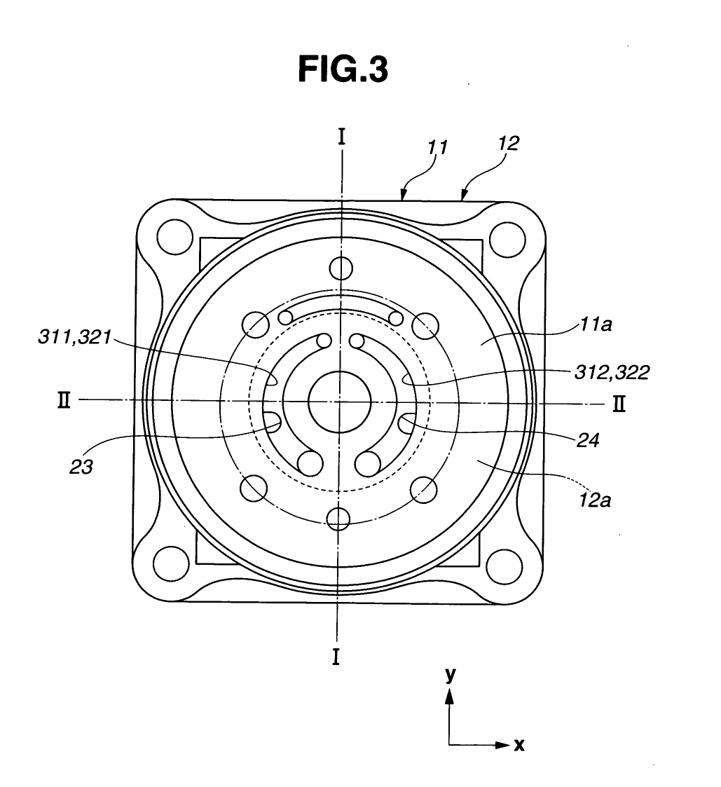

As shown in FIG. 3, this pump 3 is provided with a first induction port 311, a first discharge port 312, a second induction port 321, and a second discharge port 322 (a pair of discharge ports). A piston 8c is provided within power cylinder 8, and is arranged to move in the axial direction. This piston 8c defines a first cylinder 8a and a second cylinder 8b (a pair of pressure chambers).

First cylinder 8a is connected to a first hydraulic passage 21. First hydraulic passage 21 is connected through a third hydraulic passage 23 to pump 3. Second cylinder 8b is connected to a second hydraulic passage 22. Second hydraulic passage 22 is connected through a fourth hydraulic passage 24 to pump 3. Third and fourth hydraulic passages 23 and 24 are provided, respectively, with first and second supply hydraulic passages 61 and 62 so that third and fourth hydraulic passages 23 and 24 are connected to reservoir tank 9.

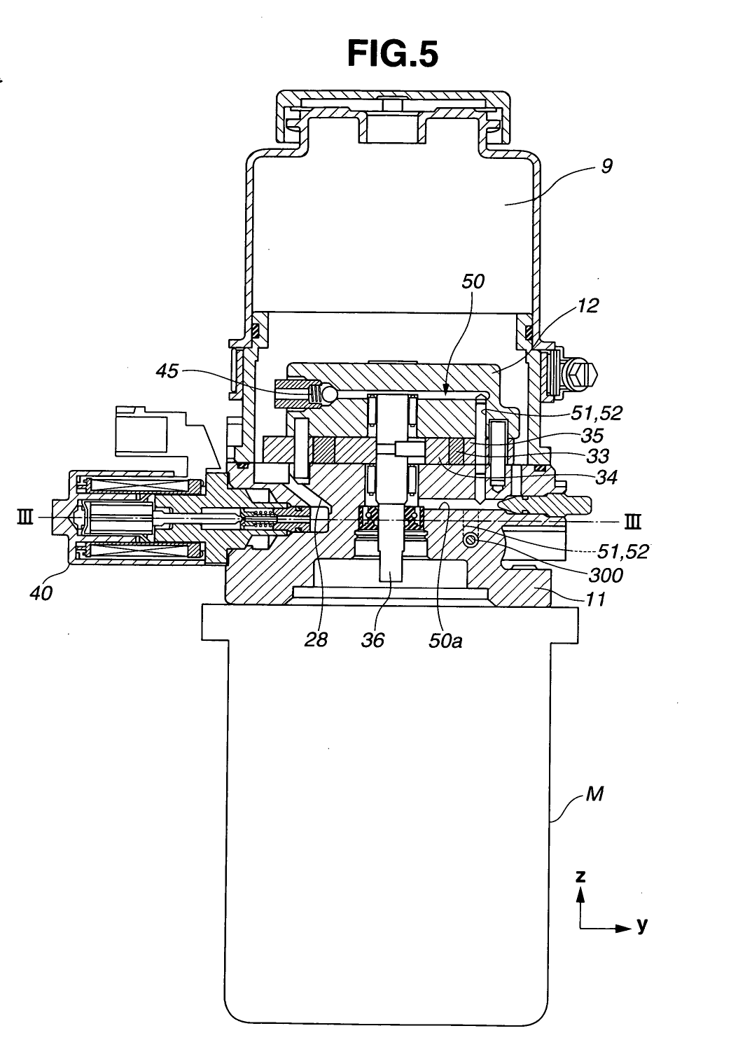

First and second supply hydraulic passages 61 and 62 are provided, respectively, with induction check valves 41 and 42 which are arranged to prevent backflows of the hydraulic fluid to reservoir tank 9, and to supply the hydraulic fluid from reservoir tank 9 in case of deficiency of the hydraulic fluid of first and second hydraulic passages 21 and 22. Besides, a hydraulic fluid leakage of pump 3 is introduced through a hydraulic passage 50a to reservoir 9, as shown in FIG. 5.

First and second hydraulic passages 21 and 22 are connected, respectively, to first and second connection passages 25 and 26. First and second connection passages 25 and 26 are connected with each other at a connection portion 27. First and second connection passages 25 and 26 are provided, respectively, with check valves 43 and 44, which are arranged to allow only flow to connection portion 27. Connection portion 27 is connected to reservoir tank 9 through a drain hydraulic passage 28 provided with an electromagnetic changeover valve 40. Connection portion 27 is connected or disconnected to reservoir tank 9 by electromagnetic changeover valve 40.

In first and second hydraulic passages 21 and 22 between pump 3 and power cylinder 8, there is a bypass valve 1 including a first bypass valve 100 connected with first hydraulic passage 21, and a second bypass valve 200 connected with second hydraulic passage 22.

First bypass valve 100 connects a pump side hydraulic passage 21a and a cylinder side hydraulic passage 21b of first hydraulic passage 21, and is arranged to connect and shut off between first hydraulic passage 21 and reservoir tank 9. Similarly, second bypass valve 200 connects a pump side hydraulic passage 22a and a cylinder side hydraulic passage 22b of second hydraulic passage 22, and is arranged to connect and shut off between second hydraulic passage 22 and reservoir tank 9.

Moreover, first and second bypass valves 100 and 200 are connected to reservoir tank 9, respectively, through first and second hydraulic passages 51 and 52 of a bypass hydraulic passage 50. When first hydraulic passage 21 is connected with first bypass hydraulic passage 51, second hydraulic passage 22 is not connected with second bypass hydraulic passage 52. When second hydraulic passage 22 is connected with second bypass hydraulic passage 52, first hydraulic passage 21 is not connected with first bypass hydraulic passage 51.

In bypass hydraulic passage 50, there is provided a back pressure valve 45 arranged to allow only flow to reservoir tank 9 to prevent a backflow from reservoir tank 9. Accordingly, it is possible to further prevent reduction of the pressure on an upstream side (pump side) of back pressure valve 45.

Control unit 7 is provided with a transmission signal receiving section 7a arranged to receive a transmission signal. Control unit 7 receives the torque signal from torque sensor TS, the transmission signal, a switch signal from an ignition switch, an engine rotational speed signal from an engine rotational speed sensor, a vehicle speed signal from a vehicle speed sensor and so on, and determines the steering assist force based on the above-described signals. Control unit 7 outputs a command signal to motor M and electromagnetic changeover valve 40. Normally open electromagnetic switch valve 40 is shut off in a normal condition, and is opened in a fail condition, so as to ensure a manual steering.

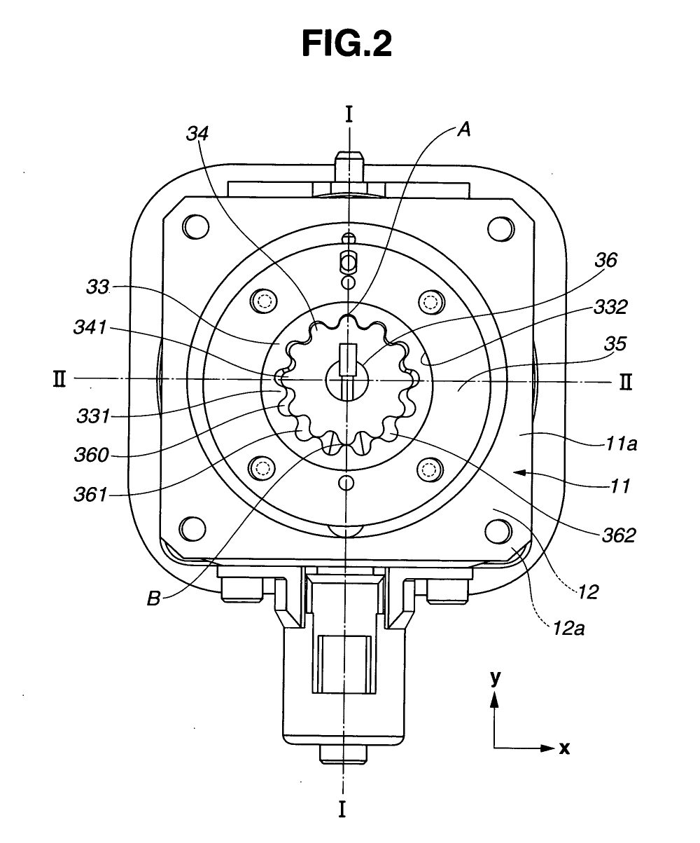

FIG. 2 shows a top view of pump 3 that a second housing 12 is removed. FIG. 3 shows a top view of a first housing 11. In FIGS. 2 and 3, a z-axis direction is a normal direction of each of FIGS. 2 and 3. The only first housing 11 is illustrated in FIGS. 2 and 3, and a bottom view of pump 3 that first housing 11 is removed is identical to FIG. 2. Configuration of portion that cam ring 35 and so on is received in first housing is identical to configuration of portion that cam ring 35 is received in second housing 12. Therefore, an explanation about second housing 12 is omitted.

Pump 3 is a reversible pump including first housing 11, second housing 12, an outer rotor 33, an inner rotor 34, a cam ring 35, and a driving shaft 36. Outer rotor 33 is disposed radially between inner rotor 34 and cam ring 35. Outer rotor 33, inner rotor 34, and cam ring 35 are received axially between first and second housings 11 and 12 to be sandwiched by first and second housings 11 and 12.

Outer rotor 33 has an inner circumference provided with an internal gear or internally-toothed gear 331, and an outer circumference 332 on which cam ring 35 is supported rotatably. On the inner circumference of outer rotor 33, there is received inner rotor 34 provided with an external gear or externally-toothed gear 341. Internal gear 331 and external gear 341 have the same pitch. The number of teeth of internal gear 331 is greater than the number of teeth of the external gear 341 by one.

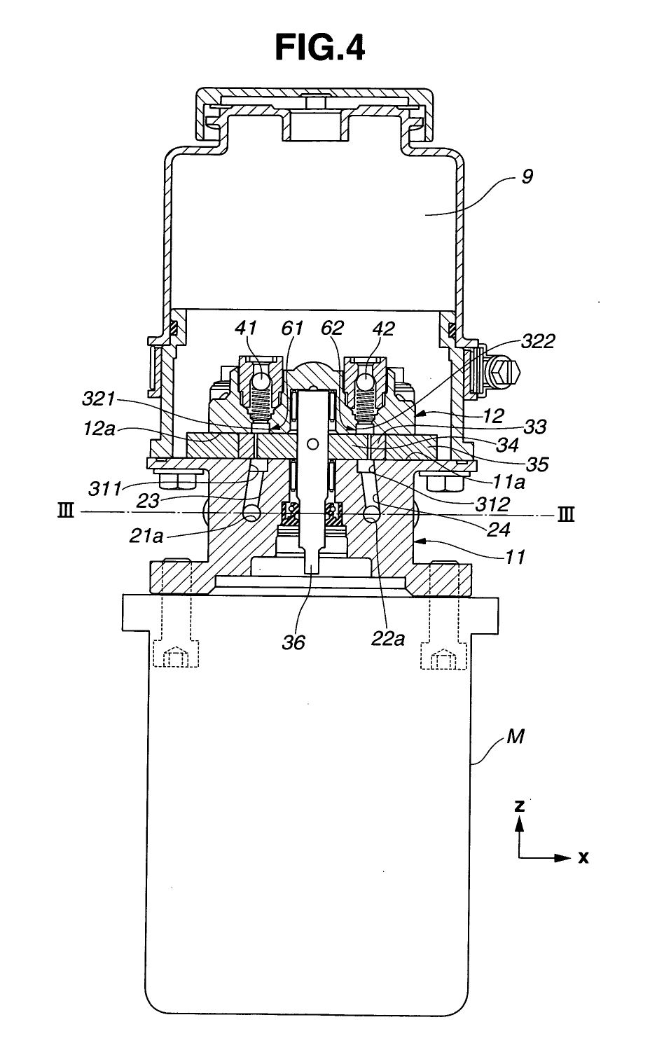

As shown in FIG. 3, a first induction port 311 is provided on a z-axis positive surface 11a of first housing 11 on a left side of line I-I (in a region in a negative direction of the x-axis) of FIG. 3, and a first discharge port 312 is provided on z-axis positive surface 11a on a right side of line I-I of (in a region of a positive direction of the x-axis) of FIG. 3. First induction port 311 and first discharge port 312 are located at positions corresponding to internal gear 331 provided in outer rotor 33 and external gear 341 provided in inner rotor 34. Each of first induction port 311 and first discharge port 312 is opened in the form of the C-shaped form, and closed in the vicinity of line I-I. First induction port 311 and first discharge port 312 are symmetrical with respect to line I-I, as shown in FIG. 4.

Similarly, second induction port 321 and second discharge port 322 are provided in second housing 12, and are in the form of the C-shaped form. Second induction port 321 and second discharge port 322 are closed in the vicinity of line I-I.

Outer rotor 33 and inner rotor 34 are received so that internal gear 331 and external gear 341 are engaged with each other. In this case, internal gear 331 is engaged with external gear 341 in an eccentric state that external gear 341 has a center axis which is off a center axis of internal gear 331 because the number of teeth of internal gear 331 is greater than the number of external gear 341 by one. Consequently, there is formed a pump chamber 360 separated by internal gear 331 and external gear 341 by the eccentricity.

Because outer rotor 33 has the center axis which is off the center axis of inner rotor 34, internal gear 331 is thickly engaged with external gear 341 toward the positive direction of the y-axis. At an end portion A in the positive direction of the y-axis, internal gear 331 and external gear 341 are completely engaged with each other, so that pump chamber 360 becomes a minimum volume. Internal gear 331 and external gear 341 are disengaged toward the negative direction of the y-axis. At an end portion B in the negative direction of the y-axis, internal gear 331 and external gear 341 are completely disengaged, so that pump chamber 360 becomes a maximum volume. Besides, at end portion B, there is provided a clearance between internal gear 331 and external gear 341 so as to avoid interference of internal gear 331 and external gear 341 so that the clearance becomes substantially zero.

That is, when inner rotor 34 and outer rotor 33 are rotated in a counterclockwise direction, a region of pump chamber 360 in the negative direction of the x-axis of line I-I (corresponding to first and second induction ports 311 and 321) becomes an induction region 361 whose volume is increased in accordance with the rotation, and a region of pump chamber 360 in the positive direction of the x-axis of line I-I (corresponding to first and second discharge ports 312 and 322) becomes a discharge region 362 whose volume is decreased in accordance with the rotation.

Driving shaft 36 provided in parallel to the z-axis is connected to motor M shown in FIG. 1, to drive inner rotor 34. By the engagement of inner rotor 34 and outer rotor 33, inner rotor 34 and outer rotor 33 are rotated with the rotation of driving shaft 36. Driving shaft 36 is arranged to rotate in the positive and reverse directions, so that pump 3 serves as a reversible pump.

Control unit 7 increases a driving signal of motor M in a direction to restrain flow rates (quantities of flows per unit time) at first and second bypass valves 100 and 200. By increasing the driving signal of motor M in the direction to restrain the flow rates at first and second bypass valves 100 and 200, the increases of the flow rates at first and second bypass valves 100 and 200 are restrained.

Control unit 7 controls to increase the driving signal of motor M when a turning state or steering state of rack shaft 5 and pinion 4 is finished. When the turning state of rack shaft 5 and pinion 4 is finished, the hydraulic fluid flows immediately in a direction opposite to the turning direction, so that the flow rates at first and second bypass valves 100 and 200 are increased. In this case, by controlling to increase the driving signal of motor M in the direction of the turning direction of motor M, the increases of the flow rates at first and second bypass valves 100 and 200 are restrained.

Control unit 7 controls to increase the driving signal of motor M when power cylinder 8 is in a lock state, that is, when rack shaft 5 and pinion 4 are in an abutting state.

When the turning state of the steering mechanism is finished by the lock of power cylinder 8, the pressure of the pressure chamber on the turning side is extremely large. Consequently, the pipe on the turning side is expanded by this pressure. The quantity of the hydraulic passage within the pipe is temporarily increased by the compensation for the deficiency of the hydraulic fluid caused by the expansion. However, the size of the pipe is reduced to the original size with the decrease of the hydraulic pressure, and the amount of the increase of the hydraulic fluid is discharged from the bypass valve.

In this case, the quantities of the flows per unit time of first and second bypass valves 100 and 200 are increased, and however the increases of the flow rates at first and second bypass valves 100 and 200 are restrained by increasing the driving signal of motor M in the turning direction of motor M.

Moreover, when the self aligning torque which urges in the turning direction of rack shaft 5 and pinions 4 is generated, it is judged that power cylinder 8 is in the lock state. Because the movement of power cylinder 8 in a back direction or return direction is suppressed by the self aligning torque in the turning direction, it is judged that the power cylinder 8 is in the lock state.

Control signal receiving section 7a receives a signal indicating whether the transmission of the vehicle is in the forward state or the reverse state. Control unit 7 judges whether the self aligning torque which urges power cylinder 8 in the turning direction is generated or not, in accordance with the signal from signal receiving section 7a.

There are a power steering apparatus that the self aligning torque in the turning direction is applied in the forward direction of the vehicle, and a power steering apparatus that the self aligning torque in the turning direction is applied in the reverse direction of the vehicle, in accordance with characteristics of the vehicle. Control unit 7 judges whether the self aligning torque is applied to the vehicle in the turning direction, in accordance with the vehicle characteristics and the position of the transmission.

[CONFIGURATION OF PUMP APPARATUS] FIG. 4 is a z-axis sectional view of the pump apparatus which is taken along a sectional line II-II of FIGS. 2 and 3. First housing 11 supports outer rotor 33, inner rotor 34, and cam ring 35 from the negative direction of the z-axis of FIG. 4. Second housing 12 supports outer rotor 33, inner rotor 34, and cam ring 35 from the positive direction of the z-axis of FIG. 4.

As described above, on z-axis positive direction surface 11a of first housing 11, there are provided first induction port 311 on the negative side of the x-axis of FIG. 3, and first discharge port 312 on the positive side of the x-axis of FIG. 3. On z-axis negative direction surface 12a of second housing 12, there are provided second induction port 321 on the negative side of the x-axis of FIG. 3, and second discharge port 322 on the positive side of the x-axis of FIG. 3.

Within first housing 11, there are provided hydraulic passages 21a and 22a which connect, respectively, first induction port 311 and first discharge port 312 to the hydraulic circuit of the power steering apparatus, to supply the hydraulic fluid to the hydraulic circuit. Moreover, on the negative side of the z-axis direction of first hosing 11, there is provided motor M connected to driving shaft 36.

On the positive side of the z-axis direction of second housing 12, there is provided reservoir tank 9. Moreover, within the second housing 12, there are provided first and second hydraulic fluid supply passages 61 and 62 which connect, respectively, second induction and discharge ports 321 and 322 to reservoir tank 9.

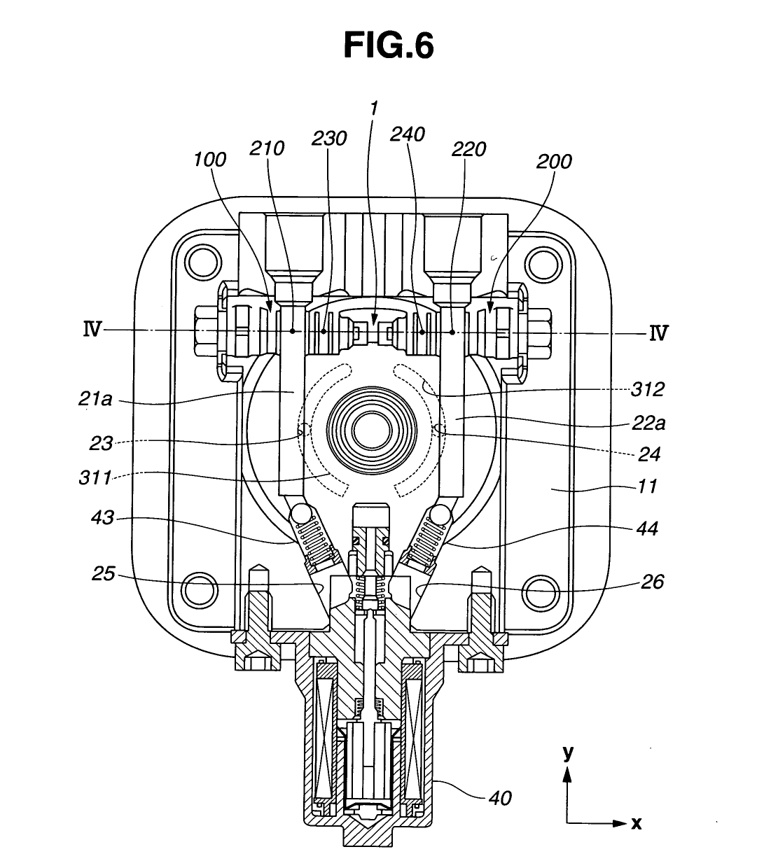

(DETAILS IN THE VICINITY OF BYPASS VALVE) FIG. 5 shows a sectional view taken along a section line I-I of FIGS. 2 and 3. FIG. 6 shows a sectional view taken along a section line III-III of FIGS. 4 and 5. Within a valve insertion hole 11b of first housing 11, there is provided bypass valve 1. On the negative side of the y-axis, there is provided electromagnetic changeover valve 40.

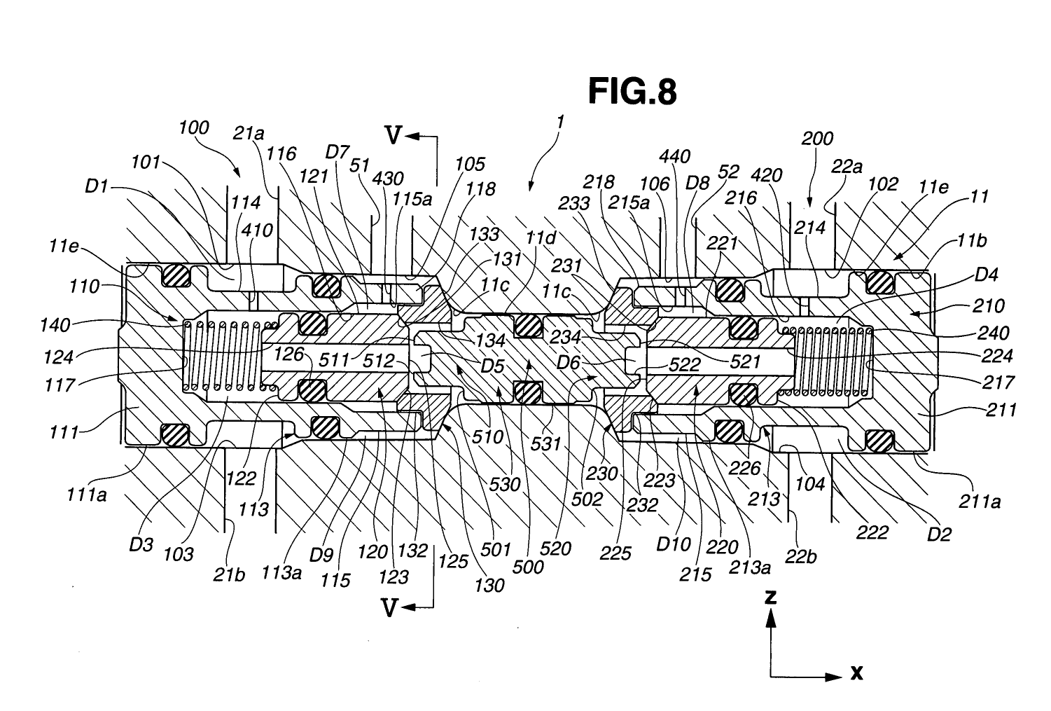

Electromagnetic changeover valve 40 and bypass valve 1 are connected by first and second hydraulic passages 21 and 22 and first and second connection passages 25 and 26 which are provided in first housing 11. As shown in FIG. 8, first bypass valve 100 is connected to first hydraulic passage 21 at an opening 101, and second bypass valve 200 is connected to second fluid passage 22 at an opening 102.

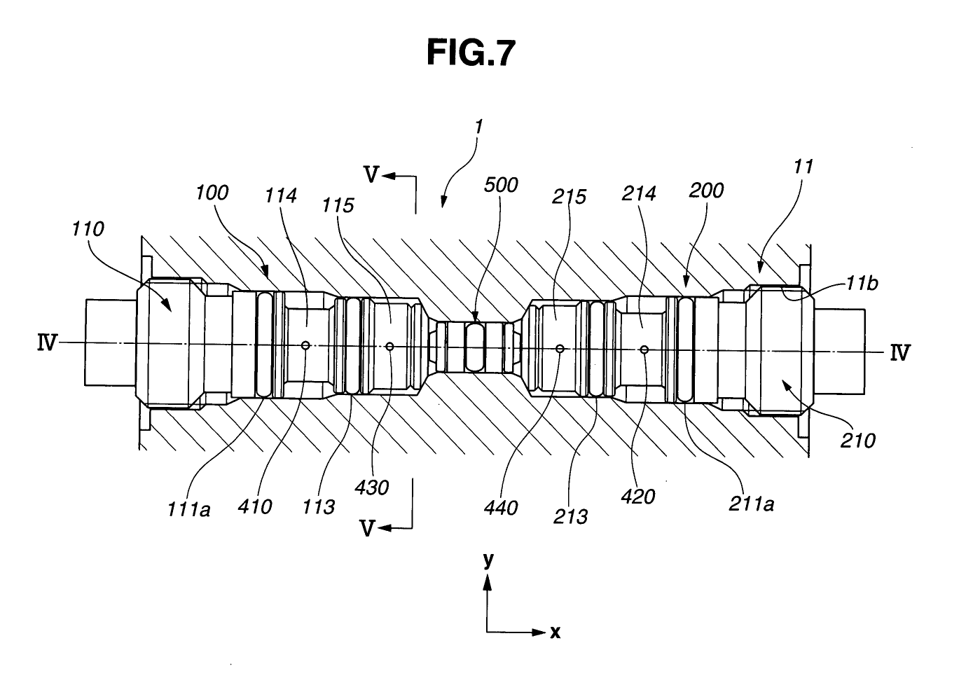

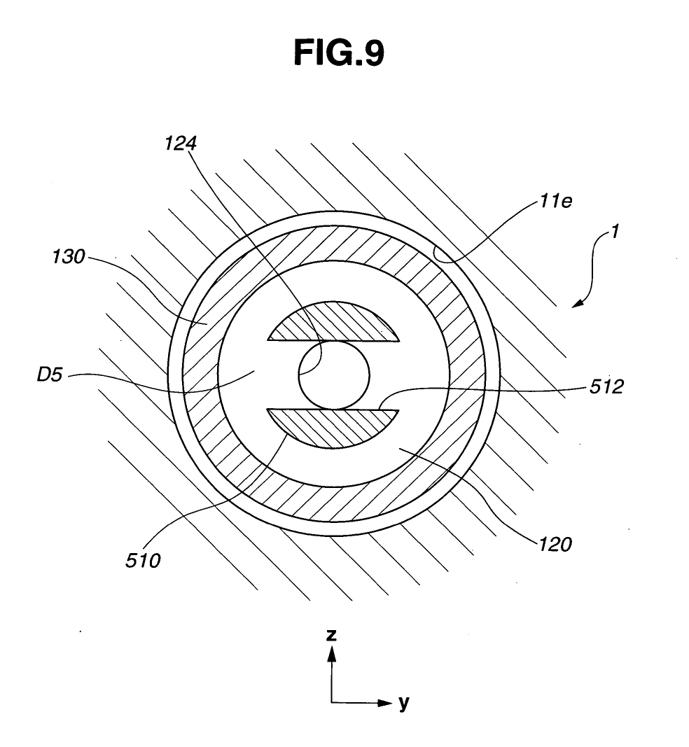

Moreover, bypass hydraulic passage 50 is formed by first and second bypass hydraulic passages 51 and 52 which are connected with each other within second housing 12. Bypass hydraulic passage 50 is opened in reservoir tank 9. First and second bypass hydraulic passages 51 and 52 are connected with bypass valve 1, respectively, at bypass hydraulic passage openings 105 and 106.

[DETAILS OF BYPASS VALVE] FIG. 7 is a front view of bypass valve 1 in the positive direction of the z-axis. FIG. 8 is a sectional view taken along a sectional line IV-IV of FIG. 7 (at a non-assist state). FIG. 9 is a sectional view taken along a sectional line V-V of FIG. 7. Hereinafter, an inside of the x-axis direction is defined by the positive direction of the x-axis of first bypass valve 100, and by the negative direction of the x-axis of second bypass valve 200. An outside of the x-axis direction is defined by the negative direction of the x-axis of first bypass valve 100, and by the positive direction of the x-axis of the second bypass valve 200.

As described above, bypass valve 1 is composed of first and second bypass valves 100 and 200. First bypass valve 100 includes a cover members 110, a valve member 120, and a valve seat 130 which are disposed, in this order, from the outside of the x-axis direction, as shown in FIG. 8. Similarly, second bypass valve 200 includes a cover member 210, a valve members 220, and a valve seat 230 which are disposed, in this order, from the outside of the x-axis direction, as shown in FIG. 8. First and second bypass valves 100 and 200 are separated by a separation member 500 slidable in the x-direction.

Moreover, first and second bypass valves 100 and 200 are provided with orifices 410˜440 (first and second flow rate restricting sections). Pump hydraulic passage orifices 410 and 420 (first and second pressure-decrease restricting section) are provided, respectively, in the vicinities of pump side opening portions 101 and 102 connected, respectively, with first and second pump side passages 21a and 22a. Bypass hydraulic passage orifices 430 and 440 are provided, respectively, in the vicinities of bypass hydraulic passage openings 105 and 106 which are connected, respectively, with first and second bypass hydraulic passages 51 and 52.

Each of orifices 410˜440 has a diameter smaller than diameters of first hydraulic passage 21 and second hydraulic passage 22. Thereby, the flow rates of first and second bypass valves 100 and 200 are decreased.

Besides, it is necessary that these orifices 410˜440 are provided to suppress the flows from first and second pump side hydraulic passages 21a and 22a to bypass hydraulic passage 50. Accordingly, it is optional to provide orifices 410˜440 in first and second pump side hydraulic passages 21a and 22a on upstream sides of bypass valves 100 and 200, to provide orifices 410˜440 in bypass valves 100 and 200, like the first embodiment, and to provide orifices 410˜440 in bypass hydraulic passage 50 on downstream sides of bypass valves 100 and 200.

(COVER MEMBER) Each of cover members 110 and 210 is in the form of a cup-shaped member. Cover members 110 and 210 are mounted in valve insertion hole 11b so that outside bottoms 111 and 211 of cover members 110 and 210 are positioned, respectively, on the outsides of the x-axis direction. Cover member 110 includes an opening 118 sealingly (liquid-tightly) abutted on valve seat 130, and similarly cover member 210 includes an opening 218 sealingly (liquid-tightly) abutted on valve seat 230.

Moreover, cover member 110 includes an outer circumferential surface 113 having an outside bottom circumferential surface 11a located on the outside of the x-direction, and a protruding portion 113a which protrudes radially outwards, around the entire circumference, and which are sealingly abutted on valve insertion hole 11b. Similarly, cover member 210 includes an outer circumferential surface 213 having an outside bottom circumferential surface 211a located on the outside of the x-direction, and a protruding portion 213a which protrudes radially outwards, around the entire circumference, and which are sealingly abutted on valve insertion hole 11b.

Because outside bottom circumferential surface 111b and protruding portion 113a protrude radially outwards, cover member outer circumferential surface 113 is formed with a recessed portion 114 located on the outside of the x-axis direction, and a recessed portion 115 located on the inside of the x-axis direction, so as to sandwich protruding portion 113a. Similarly, because outside bottom circumferential surface 211a and protruding portion 213a protrude radially outwards, cover member outer surface 213 is formed with a recessed portion 214 located on the outside of the x-axis direction, and a recessed portion 215 located on the inside of the x-axis direction, so as to sandwich protruding portion 213a.

Because outside bottom circumferential surfaces 111a and 211a and protrusions 113a and 213a protrude around the entire circumference, and recessed portions 114 and 214 and recessed portions 115 and 215 are also recessed around the entire circumference.

X-axis outside recessed portion 114 is located at a position of the x-axis direction which is identical to a position of the x-axis direction of first pump side hydraulic passage 21a and first cylinder side hydraulic passage 21b. X-axis outside recessed portion 214 is located at a position of the x-axis direction which is identical to a position of the x-axis direction of second pump side hydraulic passage 22a and second cylinder side hydraulic passage 22b. Accordingly, there is formed first hydraulic chamber D1 connected with first pump side opening 101 and first cylinder side opening 103, around the entire circumference of outer circumferential surface 113. Similarly, there is formed second hydraulic chamber D2 connected with second pump side opening 102 and second cylinder side opening 104 around the entire circumference of outer circumferential surface 213.

X-axis inside recessed portion 115 is located at a position of the x-axis direction which is identical to (aligned with) a position of the x-axis direction of first bypass hydraulic passage 51, so as to form a ninth hydraulic chamber D9 connected with first bypass hydraulic passage opening 105. X-axis inside recessed portion 215 is located at a position of the x-axis direction which is identical to (aligned with) a position of the x-axis direction of second bypass hydraulic passage 52, so as to form a tenth 10 hydraulic chamber D10 connected with second bypass hydraulic passage opening 106. Moreover, inner circumferential portions 115a and 215a of x-axis inside recessed portions 115 and 215 have inside diameters which are larger than inside diameters of protruding portions 113a and 213a, respectively. Accordingly, there are formed a gap between inner circumferential portion 115a and valve member 120, and a gap between inner circumferential portion 215a and valve member 220.

(VALVE MEMBER) Each of valve members 120 and 220 is in the form of a cylinder. First valve member 120 has a cylindrical inner circumferential surface defining a through hole 124 which extends in the x-axis direction. Second valve member 220 has a cylindrical inner circumferential surface defining a through hole 224 which extends in the x-axis direction. First and second valve members 120 and 220 are inserted, respectively, into inner circumference portions 116 and 216 of cover members 110 and 210.

On outer circumferential surfaces 121 and 221 of first and second valve members 120 and 220, there are provided sealing members 126 and 226 (first and second movement restricting sections), respectively. Accordingly, first and second valve members 120 and 220 are slidable in the x-axis direction in the sealed state in which first and second valve members 120 and 220 are sealed, respectively, to cover member inner circumference portions 116 and 216.

On the outside of the x-axis direction of valve members 120 and 220, there are provided springs 140 and 240 which have a same modulus of an elasticity (same spring modulus), so as to define third and fourth hydraulic chambers D3 and D4. Spring 140 is engaged with cover member inside bottom portion 117 and x-axis direction outside end portion 122 of valve member 120, and urges first valve member 120 in the inside direction of the x-axis direction. Similarly, spring 240 is engaged with cover member inside bottom portion 217 and x-axis direction outside end portion 222, and urges second valve member 220 in the inside direction of the x-axis direction.

Moreover, first valve member 120 is abutted on a valve member engaging portion 131 of valve seat 130 at an abutment portion 123 provided radially outside an x-axis direction inside end portion 125, so that first valve member 120 is suppressed to move in the inside direction of the x-axis. Similarly, second valve member 220 is abutted on a valve member engaging portion 231 of valve seat 230 at an abutment portion 223 provided radially outside an x-axis direction end portion 225, so that second valve member 220 is suppressed to move in the inside direction of the x-axis. Valve member engaging portions 123 and 223 are abutted, respectively, on valve member engaging portions 131 and 231 of valve seats 130 and 230 to hold the sealed state by the urging force of springs 140 and 240.

Accordingly, a gap between inner circumferential portion 115a of cover member 110 and outer circumferential surface 121 of valve member 120 is separated by the abutment between valve member 120 and valve seat 130 to define seventh hydraulic cylinder D7. Similarly, a gap between inner radial portion 215a of cover member 210 and outer circumferential surface 221 of valve member 220 is separated by the abutment between valve member 220 and valve seat 230 to define an eighth hydraulic cylinder D8.

(VALVE SEAT) Each of valve seats 130 and 230 is in the form of a substantially cylindrical shaped member. As described above, valve seats 130 and 230 are engaged, respectively, with the insides of the x-axis direction of valve members 120 and 220, at valve member engaging portions 131 and 231. Cover member mounting portions 132 and 232 of valve seats 130 and 230 are mounted, respectively, on openings 118 and 218 of cover members 110 and 210 on the inside of the x-axis direction. Cover member mounting portions 132 and 232 are stepped portions provided on the insides of the x-axis direction of valve member engaging portions 131 and 231, radially outside valve member engaging portions 131 and 231.

Moreover, valve seats 130 and 230 are abutted on valve seat engagement portions 11c of valve insertion hole 11b, respectively, at tapered surfaces 133 and 233 on the inside of the x-axis direction. Each of valve engagement portions 11c is a stepped portion (shoulder portion) shaped like a tapered form, and formed on valve insertion hole 11b. A small diameter portion 11d is located on the inside of valve engagement portions 11c in the x-axis direction, and has a diameter smaller than a diameter of a cover member insertion portions 11e located on the outsides of valve engagement portions 11c in the x-axis direction.

Each of valve seats 130 and 230 has a diameter larger than a diameter of small diameter portion 11d, and accordingly valve seats 130 and 230 are abutted, respectively, on tapered surfaces 133 and 233 of valve seat engagement portions 11c, to be engaged on the inside of the x-axis direction. Valve seats 130 and 230 are pressed on and sealingly abutted on valve engagement portions 11c by mounting forces of cover members 110 and 210.

(SEPARATION MEMBER) A separation member 500 includes stepped portions 501 and 502 which are located on both sides of separation member 500 in the x-axis direction, and which have a substantially cylindrical shape. Separation member 500 includes small diameter portions 510 and 520 which are located on the both sides of separation member 500, and a large diameter portion 530 which is located on the center of separation member 500. Each of small diameter portions 510 and 520 has a diameter smaller than an inside diameter of valve seats 130 and 230, and is inserted into and extend within valve inside diameter portions 134 and 234 of valve seats 130 and 230.

In this way, engagement portions 123 and 223 of valve members 120 and 220 are sealingly (liquid-tightly) abutted, respectively, on valve member engagement portions 131 and 231 of valve seats 130 and 230, and accordingly fifth and sixth hydraulic chambers D5 and D6 are separated by x-axis direction inside end portions 125 and 225 of valve members 120 and 220, valve seat inner radial portions 134 and 234, and small diameter portions 510 and 520.

These fifth and sixth hydraulic chambers D5 and D6 confront x-axis inside end portion 125 and 225 of valve members 120 and 220 respectively, and extend, respectively, around small diameter portions 510 and 520 of separation member 500, and inside grooves 512 and 522. Accordingly, fifth and sixth hydraulic chambers D5 and D6 are connected, respectively, with third and fourth hydraulic chambers D3 and D4 through through holes 124 and 224 provided in valve members 120 and 220.

Moreover, valve seat tapered surfaces 133 and 233 are sealingly engaged with valve seat engagement portions 11c of valve insertion hole 11b by bias forces of spring 140 and 240. Fifth and sixth hydraulic chambers D5 and D6 are sealingly separated, respectively, from ninth and tenth hydraulic chambers D9 and D10 which are located on the outside of valve seats 130 and 230 in the x-axis direction, and which are located radially outside valve seats 130 and 230.

X-axis direction outside end portions 511 and 521 of small diameter portions 510 and 520 are formed, respectively, with grooves 512 and 522 penetrating in the y-axis direction. Groove widths of grooves 512 and 522 are identical to a diameter of through holes 124 and 224 of valve members 120 and 220. Through holes 124 and 224 are opened, respectively, in x-axis inner end portions 125 and 255 of valve members 120 and 220, and accordingly grooves 512 and 522 are connected, respectively, with through holes 124 and 224.

Besides, it is necessary that groove 512 is connected with through hole 124, and that groove 522 is connected with through hole 224. There is no need for the penetrating holes extending in the y-axis direction.

Large diameter portion 530 includes an outer circumference 531 sealingly abutted on small diameter portion 11d of valve insertion hole 11b. Large diameter portion 530 is arranged to slide in the x-axis direction. Accordingly, first and second bypass valves 100 and 200 are sealingly separated with each other.

(ORIFICE) Pump hydraulic passage orifice 410 is provided in the vicinity of pump side opening 101 connected with first pump side passage 21a. Pump hydraulic passage orifice 420 is provided in the vicinity of pump side opening 102 connected with second pump side passage 22a. In the steering apparatus according to the embodiment, pump hydraulic passage orifice 410 is a through hole which has a small diameter, and which is formed at a side portion (circumferential portion) of the positive direction of the z-axis of x-axis outside recessed portion 114 of cover member 110. Similarly, pump hydraulic passage orifice 420 is a through hole which has a small diameter, and which is formed in a side portion (circumferential portion) of the positive direction of the z-axis of x-axis outside recessed portion 214 of cover member 210.

Similarly, pump hydraulic passage orifice 430 is provided in the vicinity of bypass hydraulic passage opening 105. Pump hydraulic passage orifice 440 is provided in the vicinity of bypass hydraulic passage opening 106. Bypass hydraulic passage orifice 430 is a through hole which has a small diameter, and which is formed on the positive side of the z-axis of recessed portion 115 located on the inside of the x-axis direction. Bypass hydraulic passage orifice 440 is a through hole which has a small diameter, and which is formed on the positive side of the z-axis of recessed portion 215 located on the inside of the x-axis direction.

[RELATIONSHIP AMONG HYDRAULIC CHAMBERS] (FIRST-THIRD HYDRAULIC CHAMBERS AND SECOND-FOURTH HYDRAULIC CHAMBER) First and second hydraulic chambers D1 and D2 are formed, respectively, around the entire circumferences of cover members 110 and 210. Accordingly, first hydraulic chamber D1 is always connected with first orifice 410 provided on the positive side of the z-axis of cover member 110. Similarly, second hydraulic chamber D2 is always connected with second orifice 420.

Accordingly, first hydraulic chamber D1 is always connected with third hydraulic chamber D3 through first orifice 410, and second hydraulic chamber D2 is always connected with fourth hydraulic chamber D4 through second orifice 420.

Orifices 410 and 420 have extremely large resistance of piping, relative to resistance of passage of hydraulic passages 21 and 22. Therefore, the hydraulic fluid flows hardly from first hydraulic chamber D1 to third hydraulic chamber D3, and the hydraulic fluid flows hardly from second hydraulic chamber D2 to fourth hydraulic chamber D4.

(THIRD-FIFTH HYDRAULIC CHAMBER AND FOURTH-SIXTH HYDRAULIC CHAMBER) As described above, third and fifth hydraulic chambers D3 and D5 are always in the connection state by through holes 124. Similarly, fourth and sixth hydraulic chambers D4 and D6 are in the connection state by through hole 224.

(FIFTH-SEVENTH HYDRAULIC CHAMBER AND SIXTH-EIGHTH HYDRAULIC CHAMBER) Groove 512 is opened in the radially outer circumference of x-axis outside end portion 511 of separation member 500, and groove 522 is opened in the radially outer circumference of x-axis outside end portion 521 of separation member 500. Accordingly, even when x-axis inside end portion 125 of valve member 120 is abutted on x-axis outside end portion 511 of separation member 500, the radially outer circumference of small diameter portion 510 and groove are in the connection state. Similarly, even when x-axis inside end portion 225 of valve member 220 is abutted on x-axis outside end portion 521 of separation member 500, the radially outer circumference of small diameter portion 520 and groove 522 are in the connection state.

Accordingly, fifth hydraulic chamber D5 always connects groove 512 and the radially outer circumference of x-axis outside end portion 511, and sixth hydraulic chamber D6 always connects groove 522 and the radially outer circumference of x-axis outside end portion 512. Therefore, when abutment portion 123 of valve member 120 is away from valve member engaging portion 131, fifth hydraulic chamber D5 is connected with seventh hydraulic chamber D7, irrespective of the position of separation member 500. Similarly, when abutment portion 223 of valve member 220 is away from valve member engaging portion 231, sixth hydraulic chamber D6 is connected with eighth hydraulic chamber D8, irrespective of the position of separation member 500.

When valve members 120 and 220 are abutted, respectively, on valve seats 130 and 230, the speeds of valve members 120 and 220 in the x-axis direction are decreased by the frictional resistance of sealing members 126 and 226 which are provided on outer circumferences of valve members 120 and 220. Accordingly, valve members 120 and 220 are not immediately abutted, respectively, on valve seats 130 and 230.

Accordingly, it is possible to prevent the sudden disconnection of fifth and seventh hydraulic chambers D5 and D7 and the sudden disconnection of sixth and eighth hydraulic chambers D6 and D8. Therefore, the flow from fifth hydraulic chamber D5 to seventh hydraulic chamber D7 and the flow from sixth hydraulic chamber D6 to eighth hydraulic chamber D8 are not immediately shut off, and are gradually shut off. Consequently, it is possible to prevent the impact of the hydraulic fluid which are caused by the immediate shutoff of the flow.

Besides, if it is possible to decrease the speeds of the movement in the x-axis direction of valve members 120 and 220, there is no need for seal members 126 and 226. Accordingly, it is optional to decrease the speeds of movement of valve members 120 and 220 by decreasing the bias forces of springs 140 and 240.

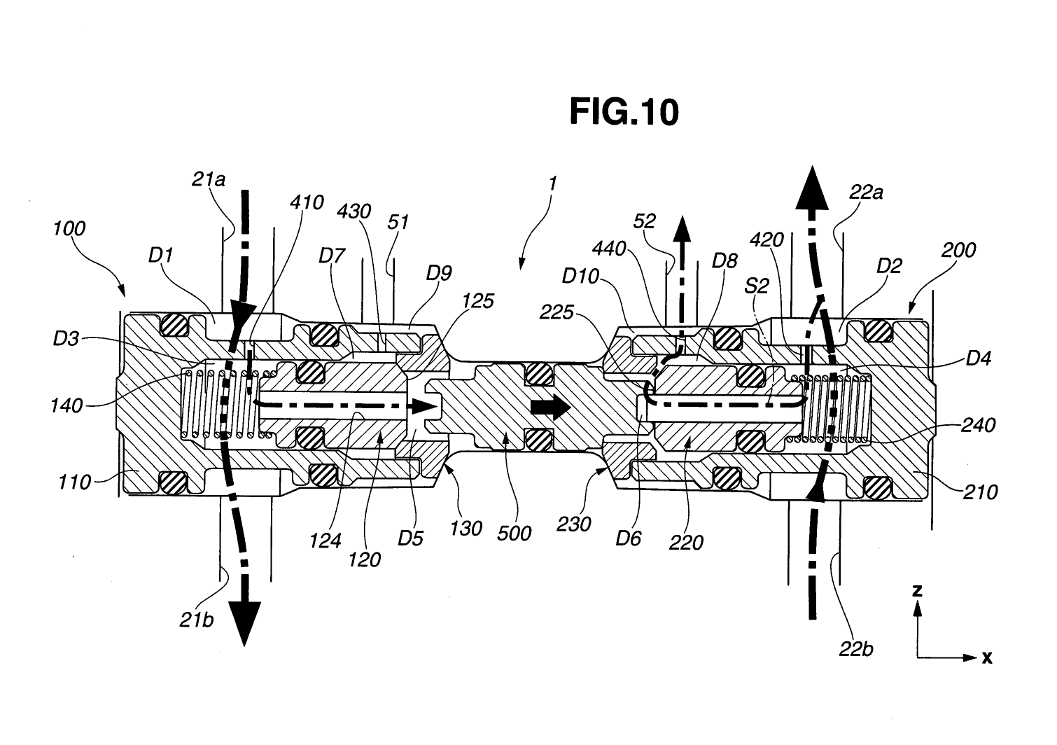

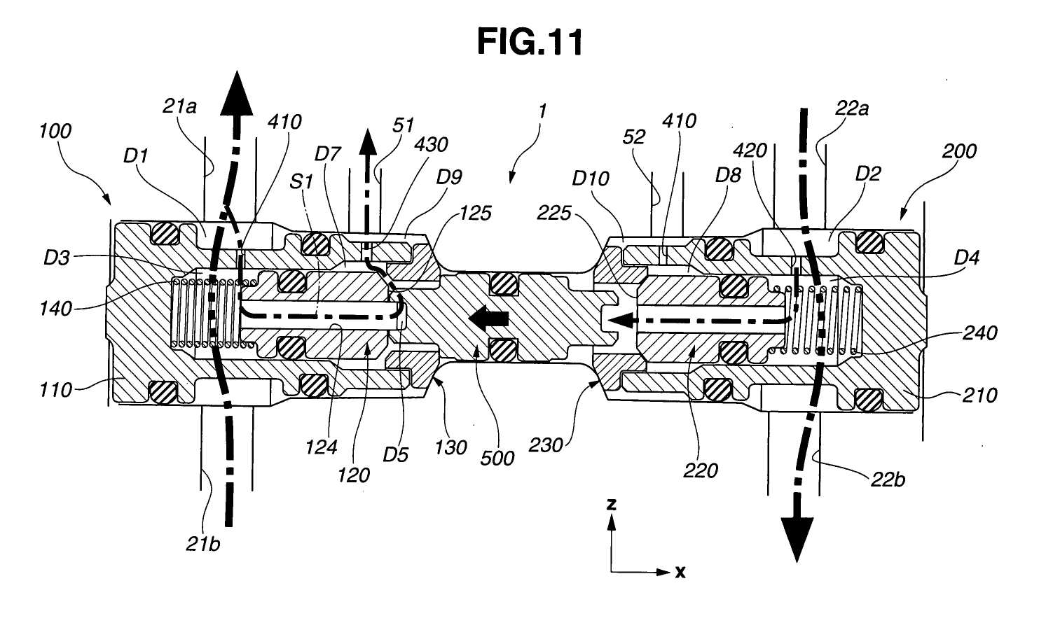

(SEVEN-NINTH HYDRAULIC CHAMBER AND EIGHTH-TENTH HYDRAULIC CHAMBER) Bypass hydraulic chamber orifices 430 and 440 are provided, respectively, on the positive sides of the z-axis of recessed portions 115 and 215 of the inside of the x-axis direction of cover members 110 and 210. Accordingly, seventh and ninth hydraulic chambers D7 and D9 are always in the connection state, and eighth and tenth hydraulic chambers D8 and D10 are always in the connection state.

[FLOW OF HYDRAULIC FLUID AT ASSIST] FIGS. 10 and 11 are sectional views taken along a section line IV-IV of FIG. 7. FIG. 10 shows bypass valve 1 at the assist that the hydraulic pressure of first cylinder 8a is increased. FIG. 11 shows bypass valve 1 at the assist that the hydraulic pressure of second cylinder 8b is increased. Chain lines indicate the flows of the hydraulic fluid. A chain line S1 indicates a flow of the hydraulic fluid from third hydraulic chamber D3 through fifth hydraulic chamber D5 to first bypass hydraulic passage 51. A chain line S2 indicates a flow of the hydraulic fluid from fourth hydraulic chamber D4 through sixth hydraulic chamber D6 to second bypass hydraulic passage 52.

(AT INCREASE OF PRESSURE OF FIRST CYLINDER) The hydraulic fluid is discharged from pump 3 to first hydraulic passage 21, and supplied through first pump side hydraulic passage 21a to first hydraulic chamber D1, and then flows into first cylinder side passage 21b and third hydraulic chamber D3. As described above, first hydraulic chamber D1 and third hydraulic chamber D3 are always in the connection state, the flow from first hydraulic chamber D1 to third hydraulic chamber D3 is restricted by the resistance of the piping of first orifice 410.

The hydraulic fluid supplied to third hydraulic chamber D3 is supplied through through hole 124 to fifth hydraulic chamber D5, and urges separation member 500 in the positive direction of the x-axis. Thereby, separation member 500 is moved in the positive direction of the x-axis, and is located at a position where first valve member 120 is not abutted on separation member 500.

First valve member 120 is urged in the positive direction of x-axis of FIG. 10, and abutted on first valve seat 130. Consequently, fifth hydraulic chamber D5 and seventh hydraulic chamber D7 are shut off, and the pump discharge pressure is not supplied to first bypass hydraulic passage 51.

On the other hand, the hydraulic fluid within second power cylinder 8b is pumped by pump 3. In second bypass valve 200, cylinder side hydraulic passage 22b is connected through second hydraulic chamber D2 to pump side hydraulic passage 22a, and the hydraulic fluid from second cylinder 8b is supplied through second hydraulic chamber D2 to pump side hydraulic passage 22a. Moreover, the hydraulic fluid within cylinder side hydraulic passage 22b is supplied through second pump hydraulic passage orifice 420 to fourth hydraulic chamber D4.

Separation member 500 is moved in the positive direction of x-axis, and abutted on x-axis inside end of second valve member 220. Consequently, separation member 500 urges second valve member 220 in the positive direction of the x-axis. When the urging force caused by separation member 500 in the positive direction of the x-axis becomes greater than the urging force caused by second spring 240 in the negative direction of the x-axis, second valve member 220 is moved in the positive direction of the x-axis against the urging force of second spring 240.

Accordingly, second valve member 220 is separated from second valve seat 230, and sixth hydraulic chamber D6 is connected with eighth hydraulic chamber D8. Therefore, the hydraulic fluid is supplied from eighth hydraulic chamber D8 through bypass hydraulic passage orifice 440 to tenth hydraulic chamber D10, and the hydraulic fluid within second cylinder 8b is discharged to second bypass hydraulic passage 52, so that flow S2 is formed as shown in FIG. 10.

(AT INCREASE OF HYDRAULIC PRESSURE OF SECOND CYLINDER) An operation at the increase of the hydraulic pressure of second power cylinder 8b is substantially identical to the operation at increase of the hydraulic pressure of first power cylinder 8a. The discharge pressure of pump 3 is supplied, to second power cylinder 8b, through second pump side hydraulic passage 22a, second hydraulic chamber D2 of second bypass valve 200, and second cylinder side hydraulic passage 22b.

The hydraulic pressure acts to fourth and sixth hydraulic chambers D4 and D6, through second hydraulic chamber D2 and second pump hydraulic passage orifice 420, and separation member 500 is urged and moved in the negative direction of the x-axis. Consequently, separation member 500 is separated from second valve member 220. Second valve member 220 is moved by the urging force of second spring 240 in the negative direction of the x-axis, and abutted on second valve seat 230.

Accordingly, the connection between sixth hydraulic chamber D6 and eighth hydraulic chamber D8 is shut off, and flow S2 flowing from second hydraulic chamber D2 to second bypass hydraulic passage 52 is shut off by switching of the assist direction from the increase of the hydraulic pressure of first power cylinder 8a to the increase of the hydraulic pressure of second power cylinder 8b.

First valve member 120 is moved in the negative direction of the x-axis with the movement of separation member 500, and consequently fifth hydraulic chamber D5 of first bypass valve 100 is connected with seventh hydraulic chamber D7 of first bypass valve 100. Therefore, the hydraulic fluid pumped from first cylinder 8a is supplied through first hydraulic chamber D1 to first pump side hydraulic passage 21a, and also discharged, to first bypass hydraulic passage 51, through third, fifth, seventh, and ninth hydraulic chambers D3, D5, D7, and D9, so that flow S1 is formed as shown in FIG. 11.

This flow S1 is shut off by the disconnection of fifth and seventh hydraulic chambers D5 and D7. That is, flow S1 is shut off at fifth hydraulic chamber D5, by switching the assist direction from the increase of the hydraulic pressure of second power cylinder 8b, to the increase of the hydraulic pressure of first power cylinder 8a, like flow S2.

[DECREASE OF DISCHARGE AMOUNT BY BYPASS HYDRAULIC PASSAGE ORIFICE] The amount of the fluid flow between seventh and ninth hydraulic chambers D7 and D9 is decreased by first bypass hydraulic passage orifice 430. Similarly, the quantity of the fluid flow between eighth and tenth hydraulic chambers D8 and D10 is decreased by second bypass hydraulic passage orifice 440.

Therefore, a flow rate (flow per unit time) of flow S1 from first cylinder 8a to bypass hydraulic passage 50 is small, and a flow rate (flow per unit time) of flow S2 from second cylinder 8b to bypass hydraulic passage 50 is small. Flows S1 and S2 become gentle flows. Accordingly, it is possible to prevent noise of impact of the hydraulic fluid, even when flows S1 and S2 are disconnected at the switching of the assist direction, because the original flow rates are small.

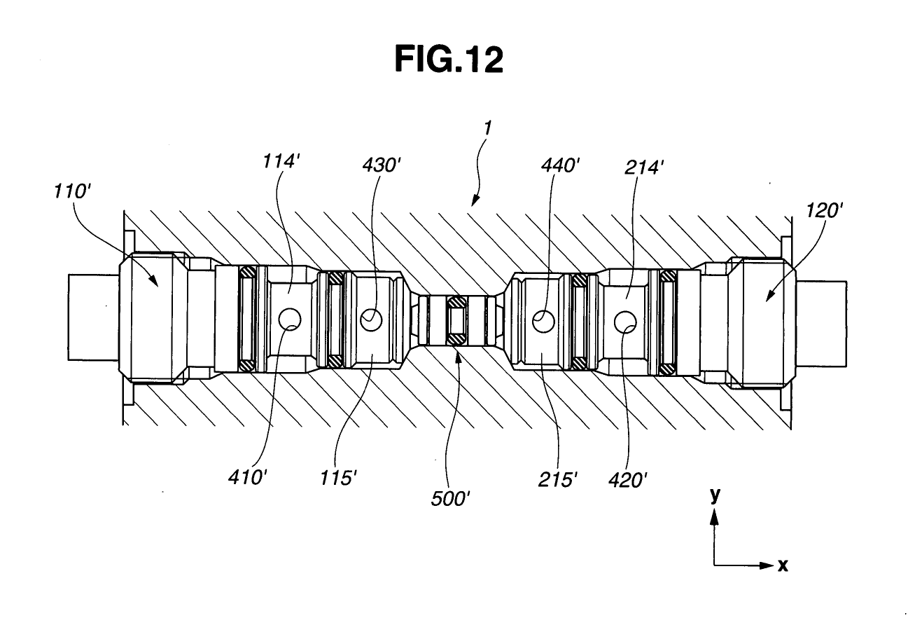

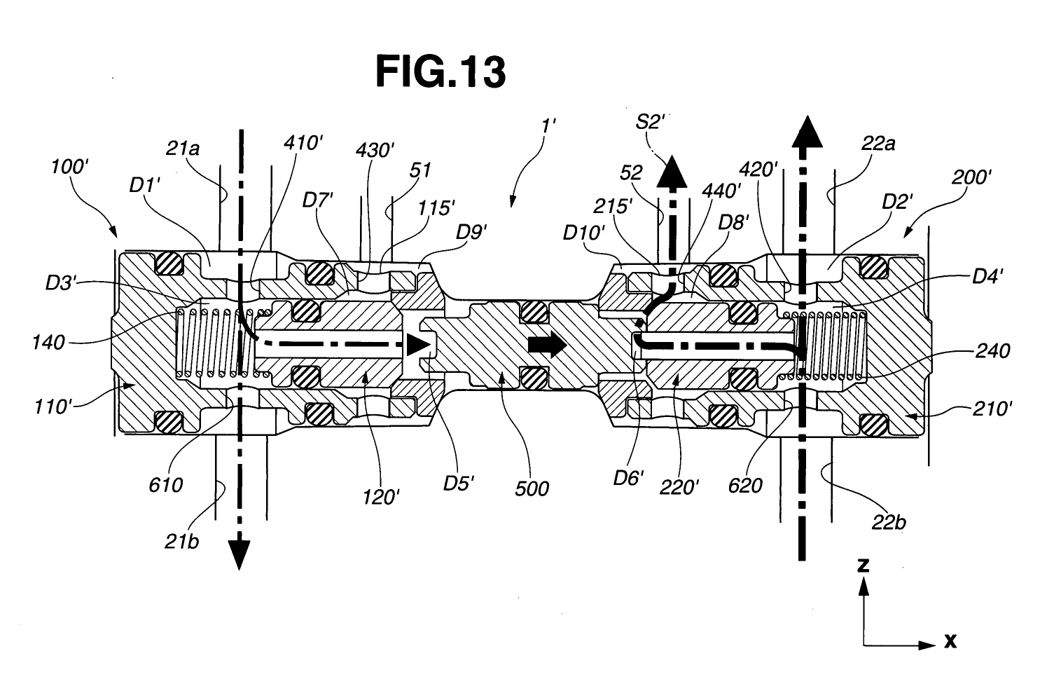

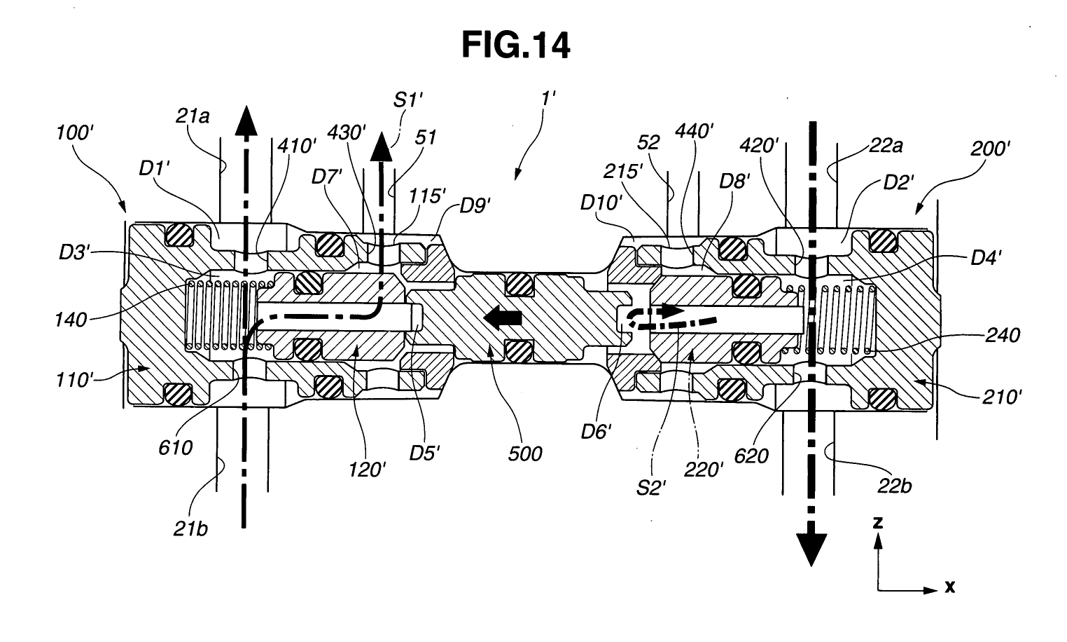

(FLOWS OF HYDRAULIC FLUID IN POWER STEERING APPARATUS OF EARLIER TECHNOLOGY) FIG. 12 is a front view showing a bypass valve 1′ of earlier technology in a positive direction of a z-axis. FIGS. 13 and 14 are sectional views as if cut by an x-z plane. FIG. 13 shows a flow of the hydraulic fluid at an assist that the hydraulic pressure of first power cylinder 8a is increased. FIG. 14 shows a flow of the hydraulic fluid immediately after the switching of the assist direction from first power cylinder 8a to second power cylinder 8b. The only hydraulic fluid in second hydraulic passage 22′ is shown by a bold line for the illustrative purposes.

In the power steering apparatus of the earlier technology, cover members 110′ and 210′ are provided, respectively, with discharge holes 610 and 620 which are arranged to discharge the hydraulic fluid, and which are located on negative sides of the z-axis of x-axis outside recessed portions 114 and 214. Discharge holes 610 and 620 are arranged to discharge the hydraulic fluid, respectively, through bypass valves 100 and 200 to bypass hydraulic passage 50 at the decrease of volumes (content) of first and second cylinders 8a and 8b. Each of discharge holes 610 and 620 has a diameter larger than diameters of orifices 410″-440 so as to restrict the resistance of the piping. Accordingly, first and second cylinder side hydraulic passages 21b and 22b are connected, respectively, with the inner circumferential sides of cover members 110′ and 210′ through first and second hydraulic chambers D1′ and D2′.

At the increase of the hydraulic pressure of first power cylinder 8a, the pump discharge pressure is supplied to first pump side hydraulic passage 21a, a first hydraulic chamber D1′, and a first cylinder side hydraulic passage 21b, and also acts to third and fifth hydraulic chambers D3′ and D5′, like the power steering apparatus according to the embodiment of the present invention (FIGS. 10 and 11). In this case, a first valve member 120′ is abutted on a first valve seat 130′ by spring 140, and fifth and seventh hydraulic chambers D5′ and D7′ are shut off.

The hydraulic fluid pumped from second cylinder 8b is supplied to second cylinder side hydraulic passage 22b, second hydraulic chamber D2′, and second pump side hydraulic passage 22a, and also discharged to second bypass hydraulic passage 52, through fourth, sixth, eighth, and tenth hydraulic chambers D4′, D6′, D8′, and D10′, so that a flow S2′ is formed.

Cover member 110′ of the earlier technology is formed with a discharge hole 430′ located on the positive direction of the z-axis of x-axis inside recessed portion 115′, and arranged to discharge the hydraulic fluid from first cylinder 8a to bypass hydraulic passage 51. Similarly, cover member 210′ of the earlier technology is formed with a discharge hole 440′ located on the positive direction of the z-axis of x-axis inside recessed portion 215′, and arranged to discharge the hydraulic fluid from second cylinder 8b to bypass hydraulic passage 52. Moreover, a connection hole 410 is provided on the positive side of the z-axis of x-axis outside recessed portion 114′, and arranged to connect first hydraulic chamber D1′ and third hydraulic chamber D3′. A connection hole 420 is provided on the positive side of the z-axis of x-axis outside recessed portion 214′, and arranged to connect second hydraulic chamber D2′ and fourth hydraulic chamber D4′.

These discharge holes 430′ and 440′ and connection holes 410′ and 420′ have a substantially identical diameter which is large so that the hydraulic fluid smoothly passes through.

[COMPARISON BETWEEN PRIOR ART AND EMBODIMENT AT SWITCHING OF ASSIST DIRECTION] Discharge holes 430′ and 440′ have a large diameter so that the hydraulic fluid smoothly passes through, and the resistance of pipeline is small. Accordingly, the flow rate of flow S1 of the hydraulic fluid discharged from first cylinder 8a to first bypass hydraulic passage 51 becomes large, and the flow rate of flow S2 of the hydraulic fluid discharged from second cylinder 8b to second hydraulic passage 52 becomes large.

Accordingly, when the connection of fifth and seventh hydraulic chambers D5 and D7 and the connection of sixth and eighth hydraulic chambers D6 and D8 are shut off at the switching of the assist direction, the impact of the hydraulic fluid is caused by the sudden shutoff of flows S1 and S2 of the large flow rates.

For example, in a case in which the assist direction is switched from the increase of the hydraulic pressure of first cylinder 8a to the increase of the hydraulic pressure of second cylinder 8b, the connection between sixth and eighth chambers D6 and D8 is shut off. On the other hand, the pump discharge pressure is supplied from second hydraulic chamber D2′ to through hole 224′ of second valve member 220′. Flow S2′ flowing in the negative direction of the x-axis within through hole 224′ is not discharged, and the impact of the hydraulic fluid is caused.

On the other hand, in the apparatus according to the embodiment, flows S1 and S2 become gentle flows which have the small flow rates, for first and second bypass hydraulic passage orifices 430 and 440. Accordingly, it is possible to prevent the impact of the hydraulic fluid at the changeover of the assist direction, unlike the power steering apparatus of the earlier technology.

[COMPARISON OF PRESSURE ON UPSTREAM SIDE OF BYPASS VALVE] Connection holes 410′ and 420′ has a large diameter, like discharge holes 430′ and 440′. Accordingly, connection hole 410′ smoothly connects pump side hydraulic passage 21 and cylinder side hydraulic passage 21b, and connection hole 420′ smoothly connects pump side hydraulic passage 22a and cylinder side hydraulic passage 22b.

The pump pressure is rapidly supplied to pump side hydraulic passages 21a and 22a and also cylinder side hydraulic passages 21b and 22b. The pump pressure tends to be escaped because the hydraulic pressure can be rapidly supplied. Accordingly, for example, the hydraulic pressure within second pump side hydraulic passage 22a does not rapidly increase at the increase of the hydraulic pressure of first cylinder 8a. Consequently, there is generated a time lag from the switching from the increase of the hydraulic pressure of first cylinder 8a to the increase of the hydraulic pressure of second cylinder 8b, until the start of the increase the fluid pressure of second pump side hydraulic passage 22a, so that the steering assist is delayed.

Therefore, in the power steering apparatus according to the embodiment, first and second orifices 410 and 420 are provided, respectively, on the positive sides of the z-axis of x-axis direction outside recessed portions 114 and 214 of first and second cover members 110 and 210. Accordingly, the flow of the hydraulic fluid from first hydraulic chamber D1 to third hydraulic chamber D3 and the flow of the hydraulic fluid from second hydraulic chamber D2 to fourth hydraulic chamber D4 are restricted.

In this way, it is possible to restrict the flow from first pump side hydraulic passage 21a to third hydraulic chamber D3 and the flow from second pump side hydraulic passage 22a to fourth hydraulic chamber D4, and to hasten the increase of the hydraulic fluid after the switching of the assist direction.

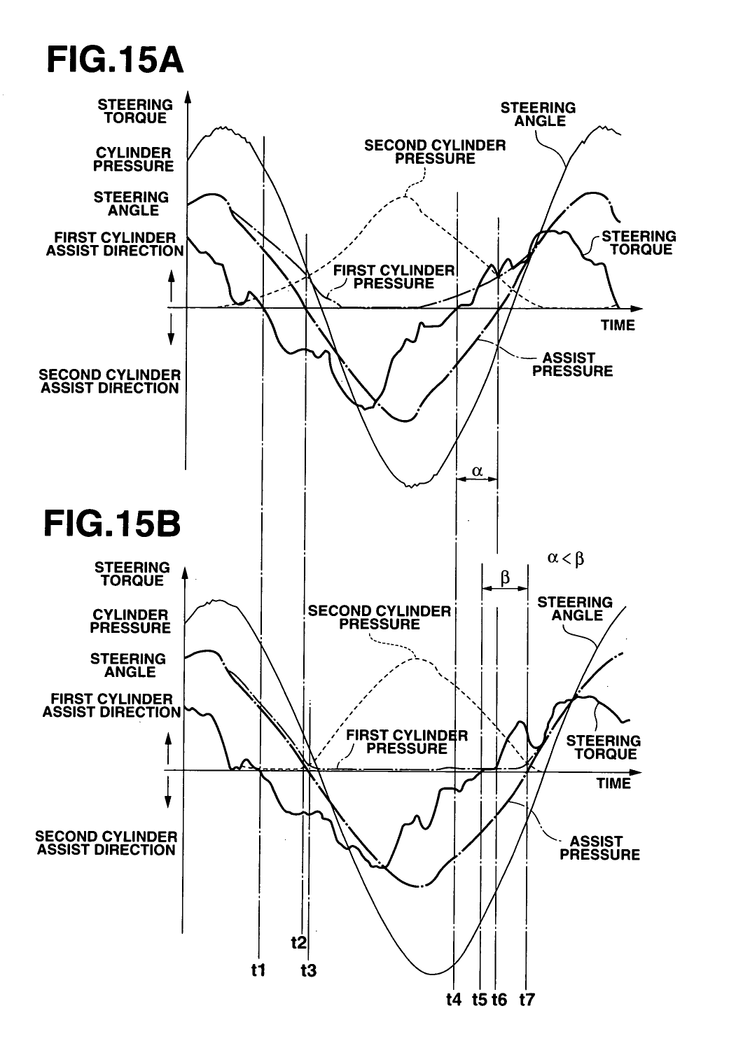

First pump side orifice 410 is provided to restrict the flow from first pump side hydraulic passage 21a to bypass hydraulic passage 50 so as to decrease the decrease of the hydraulic pressure within first pump side hydraulic passage 21a. Similarly, second pump side orifice 420 is provided to restrict the flow from second pump side hydraulic passage 22a to bypass hydraulic passage 50 so as to decrease the decrease of the hydraulic pressure within second pump side hydraulic passage 22a. Accordingly, first and second pump side orifices 410 and 420 may be formed, respectively, in first and second pump side hydraulic passages 21a and 22a located at positions upstream of bypass valves 100 and 200, and may be formed, respectively, in bypass valves 100 and 200, like the power steering apparatus according to the embodiment of the present invention. Moreover, first and second pump side orifices 410 and 420 may be formed, respectively, in bypass hydraulic passage 50 located at positions downstream of bypass valves 100 and 200.

[COMPARISON OF VARIATION WITH TIME OF ASSIST CONTROL](COMPARISON OF RESPONSE OF HYDRAULIC PRESSURE) FIG. 15A is a time chart of the assist control in a speed region of low steering angle, in the power steering apparatus according to the embodiment of the present invention. FIG. 15B is a time chart of the assist control in the speed region of low steering angle, in the power steering apparatus of the earlier technology. An axis of ordinate represents the steering torque, the assist pressure, and the steering angle.

The only speed region of the low steering angle will be illustrated because difference of the pressure response is large in the speed region of the low steering angle. In FIGS. 15A and 15B, a bold solid line shows the steering torque, a chain bold line shows the assist pressure, a thin line shows the steering angle, a thin chain line shows the pressure of first cylinder 8a, and a thin broken line shows the pressure of second cylinder 8b.

(TIME t1) At time t1, the assist direction is switched from first cylinder 8a to second cylinder 8b, in the power steering apparatus of the present invention and in the power steering apparatus of the earlier technology.

(TIME t2) At time t2, the assist pressure is switched from first cylinder 8a to second cylinder 8b in the embodiment of the present invention. In the power steering apparatus of the earlier technology, the pressure tends to escape because each of the connection holes 410′ and 420′ has the large diameter, and accordingly there is generated the time lag from the switching from the increase of first cylinder 8a to the increase of second cylinder 8b, until the start of the increase of the fluid pressure of second pump side hydraulic passage 22a. Accordingly, in the power steering apparatus of the earlier technology, the switching of the assist direction is delayed relative to the power steering apparatus according to the embodiment of the present invention.

(TIME t3) At time t3, the assist pressure of the earlier technology is switched.

(TIME t4) At time t4, in the power steering apparatus of the embodiment, the direction of the steering torque is switched from first cylinder 8a to second cylinder 8b. In the power steering apparatus of the earlier technology, the steering torque is not yet switched for the influence of a response delay between time t2 and time t3.

(TIME t5) At time t5, the direction of the steering torque of the earlier technology is switched from first cylinder 8a to second cylinder 8b.

(TIME t6) At time t6, the assist pressure of the embodiment is switched from second cylinder 8b to first cylinder 8a. In the power steering apparatus of the earlier technology, the switching of the assist direction is delayed relative to the power steering apparatus according to the embodiment, like time t2.

(TIME t7) At time t7, the assist pressure of the earlier technology is switched. A response delay time β (time period from time t5 to time t7) of the earlier technology is larger than a response delay time α (time period from time t4 to time t6) of the embodiment (α<β).

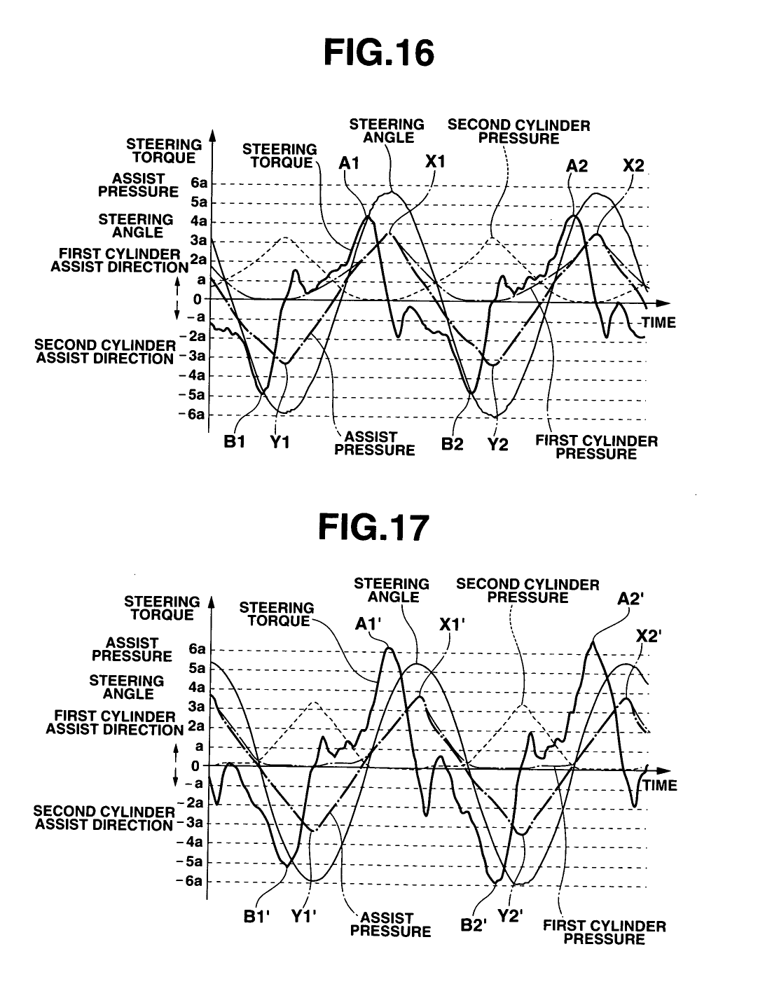

(COMPARISON OF ASSIST FORCE) FIG. 16 is a time chart of the assist control of the speed region of a high steering angle, in the power steering apparatus according to the embodiment of the present invention. FIG. 17 is a time chart of the assist control of the speed region of a high steering angle, in the power steering apparatus of the earlier technology. The only speed region of high steering angle will be illustrated because difference of the assist forces is large in the speed region of the high steering angle.

Besides, broken lines are described, at fixed intervals a, in an axis of ordinate (the steering torque) of FIGS. 16 and 17. A positive direction represents the assist direction of first cylinder 8a, and a negative direction represents the assist direction of second cylinder 8b.

In the assist pressure of the direction of first cylinder 8a, maximum values X1 and X2 of the embodiment are substantially identical to maximum values X1′ and X2′ of the earlier technology. However, in the steering torque, maximum values A1 and A2 of the embodiment are equal to or smaller than 5a, and maximum values A1′ and A2′ of the earlier technology are greater than 5a.

Similarly, in the assist pressure of the direction of second cylinder 8b, minimum values Y1 and Y2 of the embodiment are substantially identical to minimum values Y1′ and Y2′ of the earlier technology. However, in the steering torque, minimum values B1 and B2 of the embodiment are equal to or greater than −5a, and minimum values B1′ and B2′ are smaller than −5a.

That is, to generate the same assist pressure, there is need for the steering torque in the earlier technology which is larger than the steering torque of the embodiment. Accordingly, the power steering apparatus of the embodiment of the present invention has advantage in the following capability over the power steering apparatus of the earlier technology. Consequently, a load to the driver in the power steering apparatus of the earlier technology is greater than a load to the driver in the power steering apparatus of the embodiment.

[EFFECT OF THE EMBODIMENT] In the power steering apparatus of the embodiment of the present invention, the power steering apparatus includes power cylinder 8 including first and second pressure chambers (8a,8b), the power cylinder 8 being arranged to assist a steering force of a steering mechanism connected with steered wheels (6a,6b); hydraulic pump 3 including a first discharge port 321 and a second discharge port 322, the hydraulic pump 3 being arranged to supply a hydraulic pressure selectively to the first pressure chamber 8a and the second pressure chamber 8b; the first hydraulic passage connecting the first pressure chamber 8a of the power cylinder 8 and the first discharge port 321 of the hydraulic pump 3; the second hydraulic passage connecting the second pressure chamber 8b of the power cylinder 8 and the second discharge port 322 of the hydraulic pump 3; motor M arranged to drive the hydraulic pump 3; motor control section 7 configured to output a drive signal to the motor M in accordance with a steering assist force applied to the steered wheels; reservoir tank 9 storing a hydraulic fluid; first bypass passage 51 connecting the first hydraulic passage 21 and the reservoir tank 9; second bypass passage 52 connecting the second hydraulic passage 22 and the reservoir tank 9; first bypass valve 100 arranged to open and close the first bypass passage 51; second bypass valve 200 arranged to open and close the second bypass passage 52; the first flow rate restricting section (410,430) disposed in the first bypass passage 51, and arranged to decrease the flow rate of the first bypass passage 51; and the second flow rate restricting section (420,440) disposed in the second bypass passage 52, and arranged to decrease a flow rate of the second bypass passage 52.

Accordingly, the flow of the hydraulic fluid to reservoir tank 9 becomes gentle, and it is possible to restrain the noise of impact of hydraulic fluid at bypass valve 1.

In the illustrated example, the first pressure-decrease restricting section (410,430) is provided in the first bypass passage 51, and arranged to decrease a speed of a pressure decrease on an upstream side of the first bypass valve 100; and the second pressure-decrease restricting section (420,440) is provided in the second bypass passage 52, and arranged to decrease a speed of a pressure decrease on an upstream side of the second bypass valve 200.

Accordingly, the flow of the hydraulic fluid flowing through bypass hydraulic passage 50 to reservoir tank 9 becomes gentle, and it is possible to restrain the noise of impact of hydraulic fluid at bypass valve 1.

In the illustrated embodiment, first valve movement restricting section 126 is provided in the first bypass valve 100, and arranged to decrease a speed per unit time of the first bypass valve 100; and second valve movement restricting section 226 is provided in the second bypass valve 200, and arranged to decrease a speed per unit time of the second bypass valve 200.

Accordingly, the movement speeds in the x-axis direction of valve members 120 and 220 which are sealingly slid with inner circumferential portions 116 and 216 of cover members 110 and 210 are lowered. Therefore, it is possible to prevent the sudden shut-off of fifth and 10 seventh hydraulic chambers D5 and D7 and the sudden shut-off of sixth and eighth hydraulic chambers D6 and D8, and thereby to prevent the noise of the impact of the hydraulic fluid.

In the power steering apparatus according to the embodiment, each of the first and second flow rate restricting sections is the orifice.

Accordingly, it is possible to decrease the flow rate at the bypass valve, and to prevent the decrease of the pressure on the upstream side of the bypass valve. Consequently, it is possible to hasten the increase of the hydraulic pressure at the subsequent assist control.

In the power steering apparatus according to the embodiment, the first and second flow rate restricting sections are configured to increase the drive signal of the motor M to restrict the flow rates of the first and second bypass valves (100,200).

In the illustrated example, the driving signal of the motor is increased in the direction to restrict the flow rate. Accordingly, it is possible to restrain the flow rate.

In the power steering apparatus according to the embodiment, the first and second flow rate restricting sections are configured to increase the drive signal of the motor M when a turning state of the steering mechanism is finished.

When the turning state of the steering mechanism is finished, the hydraulic fluid flows suddenly in the direction opposite to the turning direction. Consequently, the flow rate at the bypass valve is increased. In this case, the driving signal of the motor is increased in the turning direction, and consequently it is possible to prevent the increase of the flow rate of the bypass valve.

In the power steering apparatus according to the embodiment, the first and second flow rate restricting sections are configured to increase the drive signal of the motor when the power cylinder 8 is in a lock state.

When the turning state of the steering mechanism is finished by the lock of the power cylinder, the pressure of the pressure chamber on the turning side becomes excessive, and consequently the pipe on the turning side is expanded by this hydraulic pressure. In this case, the flow rate within the pipe is temporarily increased by compensation for the deficiency of the hydraulic fluid which is caused by the expansion. However, the size of the pipe is decreased to the original size with the decrease of the pressure, and the increase of the hydraulic pressure is discharged from the bypass valve. In this case, the flow rate at the bypass valve is increased. However, the driving signal of the motor is increased in the turning direction of the motor, and it is possible to restrain the flow rate.

In the power steering apparatus according to the embodiment, the power steering apparatus is configured to judge that the power cylinder 8 is in the lock state when an aligning torque which urges the power cylinder in a turning direction of the steering mechanism is generated.

Accordingly, it is possible to judge the lock state of the power cylinder because the movement of the power cylinder in the return direction is restricted by the self aligning torque of the turning direction.

In the power steering apparatus according to the embodiment, the power steering apparatus further comprises a signal receiving section 7a configured to receive a signal indicative of whether a transmission of a vehicle is in a forward state (drive position) or in a reverse state (reverse position); and the first and second flow rate restricting sections are configured to judge whether the aligning torque which urges the power cylinder in the turning direction is generated, in accordance to the signal received by the signal receiving section 7a.

There are a power steering apparatus that the self aligning torque in the turning direction is applied in the forward direction of the vehicle, and a power steering apparatus that the self aligning torque in the turning direction is applied in the reverse direction of the vehicle, in accordance with characteristics of the vehicle. Accordingly, it is possible to judge whether the vehicle is applied with the self aligning torque in the turning direction, in accordance with the characteristic of the vehicle and the position of the transmission.

In the power steering apparatus according to the embodiment, the first and second flow rate restricting sections are configured to increase the drive signal of the motor M when the steering mechanism is in an abutting state.

When the steering mechanism is in the abutting state, the hydraulic pressure of the hydraulic chamber on 10 the turning side is extremely large, and the pipe on the turning side is expanded by the this hydraulic pressure. The quantity of the hydraulic fluid within the pipe is temporarily increased by the compensation for the deficiency of the hydraulic fluid which is caused by the expansion. However, the size of the pipe is reduced to the original size with the decrease of the hydraulic pressure, and the quantity of the increase of the hydraulic fluid is discharged from the bypass valve. In this case, the flow rate at the bypass valve is increased. However, the driving signal of the motor is increased in the turning direction, and accordingly it is possible to restrain the increase of the flow rate at the bypass valve.

In the power steering apparatus according to the embodiment, the power steering apparatus further comprises a back-pressure valve 45 located on a downstream side of the first and second bypass valves (100,200), and arranged to allow flows of the hydraulic fluid from the first and second bypass valves (100,200) to the reservoir tank 9 when a pressure difference is equal to or greater than a predetermined value.

In the illustrated example, the back-pressure valve is provided, and accordingly it is possible to further restrain the decrease of the hydraulic pressure on the upstream side of the back-pressure valve.

In the power steering apparatus according to the embodiment, each of the first and second flow rate restricting sections is the orifice provided on an upstream side of one of the first and second bypass valves (100,200).

Accordingly, it is possible to decrease the flow rate at the bypass valve, and to restrain the decrease of the pressure on the upstream side of the bypass valve. Consequently, it is possible to hasten the increase of the pressure in the subsequent assist control.

In the power steering apparatus according to the embodiment, each of the first and second flow rate restricting sections is the orifice provided in one of the first and second bypass valves (100,200).

Accordingly, it is possible to decrease the quantity of the flow per unit time at the bypass valve, and to restrain the decrease of the pressure on the upstream side of the bypass valve. Consequently, it is possible to hasten the increase of the pressure in the subsequent assist control.

In the power steering apparatus according to the embodiment, each of the first and second flow rate restricting sections is the orifice provided on a downstream side of one of the first and second bypass valves (100,200).

Accordingly, it is possible to decrease the flow rate at the bypass valve, and to restrain the decrease of the pressure on the upstream side of the bypass valve. Consequently, it is possible to hasten the increase of the pressure in the subsequent assist control.

In the power steering apparatus according to the embodiment, each of the orifices has a diameter smaller than diameters of first and second hydraulic passages.

In the illustrated example, the diameters of the orifices which serves as the first and second flow quantity restricting section is smaller than the diameter of the first and second hydraulic passages, and accordingly it is possible to decrease the quantity of the flow per unit time at the bypass valve.

In the power steering apparatus according to the embodiment, each of the first and second pressure-decrease restricting sections is an orifice.

Accordingly, it is possible to decrease the decreasing speed of the pressure at the bypass valve, and to restrain the decrease of the pressure on the upstream side of the bypass valve. Consequently, it is possible to hasten the increase of the pressure in the subsequent assist control.

In the power steering apparatus according to the embodiment, the power steering apparatus further comprises a back-pressure valve 45 located on a downstream side of the first and second bypass valves (100,200), and arranged to allow flows of the hydraulic fluid from the first and second bypass valves (100,200) to the reservoir tank 9 when a pressure difference is equal to or greater than a predetermined value.

In the illustrated example, the back-pressure vale is provided, and accordingly it is possible to further restrain the decrease of the pressure on the upstream side of the back-pressure valve.

In the power steering apparatus according to the embodiment, each of the first and second pressure-decrease restricting sections is the orifice provided on an upstream side of the first and second bypass valves (100,200).

Accordingly, it is possible to decrease the decreasing speed of the pressure at the bypass valve, and to restrain the decrease of the pressure on the upstream side of the bypass valve. Consequently, it is possible to hasten the increase of the pressure in the subsequent assist control.

In the power steering apparatus according to the embodiment, each of the first and second pressure-decrease restricting sections is the orifice provided on a downstream side of one of the first and second bypass valves (100,200).

Accordingly, it is possible to decrease the decreasing speed of the pressure at the bypass valve, and to restrain the decrease of the pressure on the upstream side of the bypass valve. Consequently, it is possible to hasten the increase of the pressure in the subsequent assist control.

In the power steering apparatus according to the embodiment, each of the first and second valve movement restricting sections (126,226) is a frictional member arranged to increase a sliding resistance of one of the first and second bypass valves (100,200).

In the illustrated embodiment, the frictional members decrease the movement speeds per unit time of the first and second bypass valves. Accordingly, it is possible to decrease the speeds of shutoff of first and second bypass valves, and thereby to restrain the noise of impact of the hydraulic fluid at the bypass valves.

In the power steering apparatus according to the embodiment, the first and second valve movement restricting section are springs provided in the first and second bypass valves.

In the illustrated embodiment, the bias forces of springs are decreased. Accordingly, it is possible to decrease the speeds of shutoff of the first and second bypass valves, and to restrain the noise of impact of the hydraulic fluid at bypass valves.

This application is based on a prior Japanese Patent Application No. 2005-371510. The entire contents of the Japanese Patent Application No. 2005-371510 with a filing date of Dec. 26, 2005 are hereby incorporated by reference.

Although the invention has been described above by reference to certain embodiments of the invention, the invention is not limited to the embodiments described above. Modifications and variations of the embodiments described above will occur to those skilled in the art in light of the above teachings. The scope of the invention is defined with reference to the following claims.

What is claimed is:

1. A power steering apparatus comprising:
a power cylinder including first and second pressure chambers, the power cylinder being arranged to assist a steering force of a steering mechanism connected with steered wheels;
a hydraulic pump including a first discharge port and a second discharge port, the hydraulic pump being arranged to supply a hydraulic pressure selectively to the first pressure chamber and the second pressure chamber;
a first hydraulic passage connecting the first pressure chamber of the power cylinder and the first discharge port of the hydraulic pump;
a second hydraulic passage connecting the second pressure chamber of the power cylinder and the second discharge port of the hydraulic pump;
a motor arranged to drive the hydraulic pump;
a motor control section configured to output a drive signal to the motor in accordance with a steering assist force applied to the steered wheels;
a reservoir tank storing a hydraulic fluid;
a first bypass passage connecting the first hydraulic passage and the reservoir tank;
a second bypass passage connecting the second hydraulic passage and the reservoir tank;
a first bypass valve arranged to open and close the first bypass passage;
a second bypass valve arranged to open and close the second bypass passage;
a first flow rate restricting section disposed in the first bypass passage, and arranged to decrease a flow rate of the first bypass passage; and
a second flow rate restricting section disposed in the second bypass passage, and arranged to decrease a flow rate of the second bypass passage.

2. The power steering apparatus as claimed in claim 1, wherein each of the first and second flow rate restricting sections is an orifice.

3. The power steering apparatus as claimed in claim 1, wherein the first and second flow rate restricting sections are configured to increase the drive signal of the motor to restrict the flow rates of the first and second bypass valves.

4. The power steering apparatus as claimed in claim 3, wherein the first and second flow rate restricting sections are configured to increase the drive signal of the motor when a turning state of the steering mechanism is finished.

5. The power steering apparatus as claimed in claim 4, wherein the first and second flow rate restricting sections are configured to increase the drive signal of the motor when the power cylinder is in a lock state.

6. The power steering apparatus as claimed in claim 5, wherein the power steering apparatus is configured to judge that the power cylinder is in the lock state when an aligning torque which urges the power cylinder in a turning direction of the steering mechanism is generated.

7. The power steering apparatus as claimed in claim 6, wherein the power steering apparatus further comprises a signal receiving section configured to receive a signal indicative of whether a transmission of a vehicle is in a forward state or in a reverse state; and the first and second flow rate restricting sections are configured to judge whether the aligning torque which urges the power cylinder in the turning direction is generated, in accordance to the signal received by the signal receiving section.

8. The power steering apparatus as claimed in claim 3, wherein the first and second flow rate restricting sections are configured to increase the drive signal of the motor when the steering mechanism is in an abutting state.

9. The power steering apparatus as claimed in claim 2, wherein the power steering apparatus further comprises a back-pressure valve located on a downstream side of the first and second bypass valves, and arranged to allow flows of the hydraulic fluid from the first and second bypass valves to the reservoir tank when a pressure difference is equal to or greater than a predetermined value.

10. The power steering apparatus as claimed in claim 2, wherein each of the first and second flow rate restricting sections is the orifice provided on an upstream side of one of the first and second bypass valves.

11. The power steering apparatus as claimed in claim 2, wherein each of the first and second flow rate restricting sections is the orifice provided in one of the first and second bypass valves.

12. The power steering apparatus as claimed in claim 2, wherein each of the first and second flow rate restricting sections is the orifice provided on a downstream side of one of the first and second bypass valves.

13. The power steering apparatus as claimed in claim 2, wherein each of the orifices has a diameter smaller than diameters of first and second hydraulic passages.

14. A power steering apparatus comprising:
a power cylinder including first and second pressure chambers, the power cylinder being arranged to assist a steering force of a steering mechanism connected with steered wheels;
a hydraulic pump including a first discharge port and a second discharge port, the hydraulic pump being arranged to supply a hydraulic pressure selectively to the first pressure chamber and the second pressure chamber;
a first hydraulic passage connecting the first pressure chamber of the power cylinder and the first discharge port of the hydraulic pump;
a second hydraulic passage connecting the second pressure chamber of the power cylinder and the second discharge port of the hydraulic pump;
a motor arranged to drive the hydraulic pump;
a motor control section configured to output a drive signal to the motor in accordance with a steering assist force applied to the steered wheels;
a reservoir tank storing a hydraulic fluid;
a first bypass passage connecting the first hydraulic passage and the reservoir tank;
a second bypass passage connecting the second hydraulic passage and the reservoir tank;
a first bypass valve arranged to open and close the first bypass passage;
a second bypass valve arranged to open and close the second bypass passage;
a first pressure-decrease restricting section provided in the first bypass passage, and arranged to decrease a speed of a pressure decrease on an upstream side of the first bypass valve; and
a second pressure-decrease restricting section provided in the second bypass passage, and arranged to decrease a speed of a pressure decrease on an upstream side of the second bypass valve.

15. The power steering apparatus as claimed in claim 14, wherein each of the first and second pressure-decrease restricting sections is an orifice.

16. The power steering apparatus as claimed in claim 15, wherein the power steering apparatus further comprises a back-pressure valve located on a downstream side of the first and second bypass valves, and arranged to allow flows of the hydraulic fluid from the first and second bypass valves to the reservoir tank when a pressure difference is equal to or greater than a predetermined value.

17. The power steering apparatus as claimed in claim 15, wherein each of the first and second pressure-decrease restricting sections is the orifice provided on an upstream side of the first and second bypass valves.

18. The power steering apparatus as claimed in claim 15, wherein each of the first and second pressure-decrease restricting sections is the orifice provided on a downstream side of one of the first and second bypass valves.

19. A power steering apparatus comprising:
a power cylinder including first and second pressure chambers, the power cylinder being arranged to assist a steering force of a steering mechanism connected with steered wheels;
a hydraulic pump including a first discharge port and a second discharge port, the hydraulic pump being arranged to supply a hydraulic pressure selectively to the first pressure chamber and the second pressure chamber;
a first hydraulic passage connecting the first pressure chamber of the power cylinder and the first discharge port of the hydraulic pump;
a second hydraulic passage connecting the second pressure chamber of the power cylinder and the second discharge port of the hydraulic pump;
a motor arranged to drive the hydraulic pump;
a motor control section configured to output a drive signal to the motor in accordance with a steering assist force applied to the steered wheels;
a reservoir tank storing a hydraulic fluid;
a first bypass passage connecting the first hydraulic passage and the reservoir tank;
a second bypass passage connecting the second hydraulic passage and the reservoir tank;
a first bypass valve arranged to open and close the first bypass passage;
a second bypass valve arranged to open and close the second bypass passage;
a first valve movement restricting section provided in the first bypass valve, and arranged to decrease a speed per unit time of the first bypass valve; and
a second valve movement restricting section provided in the second bypass valve, and arranged to decrease a speed per unit time of the second bypass valve.

20. The power steering apparatus as claimed in claim 19, wherein each of the first and second valve movement restricting sections is a frictional member arranged to increase a sliding resistance of one of the first and second bypass valves.
